(19) United States
(12) Patent Application Publication
(10) Pub. No.: US 2009/0096962 A1
(43) Pub. Date: Apr. 16, 2009

(54) Cellulose Esters with High Hyrdoxyl Content and Their Use in Liquid Crystal Displays

(75) Inventors: Michael Charles Shelton, Kingsport, TN (US); Ted Calvin Germroth, Kingsport, TN (US); Dong Zhang, Uniontown, OH (US); Frank Wayne Harris, Boca Raton, FL (US)

Correspondence Address: LOUIS N. MORENO, P.O. BOX 511 , B-75, KINGSPORT, TN, 37662, US

(73) Assignee: EASTMAN CHEMICAL COMPANY, Kingsport, TN (US)

(21) Appl. No.: 12/100,092

(22) Filed: Apr. 9, 2008

Related U.S. Application Data
(60) Provisional application No. 60/930,152, filed on May 14, 2007.
(60) Provisional application No. 60/937,528, filed on Jun. 28, 2007.

(51) Int. Cl. G02F 1/1335; C08B 3/06; C09D 101/12; B32B 23/20; F21V 9/06; C09K 19/52; C09K 19/00

(52) U.S. Cl. 349/96; 536/69; 106/171.1; 106/170.15; 106/170.16; 428/220; 252/589; 252/299.01; 428/1.1

(57) ABSTRACT

The invention relates to the preparations and uses of cellulose esters with a high degree of substitution of hydroxyl groups (also called high DS_{OH} cellulose esters) as substrates and/or negative C-plate optical compensation films in LCD applications.

### CROSS-REFERENCE TO RELATED APPLICATIONS

This application claims priority to U.S. Provisional Application Ser. Nos. 60/930,152, filed May 14, 2007 and 60/937,528, filed Jun. 28, 2007, the disclosures of which are incorporated herein by reference in their entirety to the extent they do not contradict statements herein.

### BACKGROUND OF THE INVENTION

The present invention relates to high hydroxyl content cellulose esters. More particularly, the present invention relates to high hydroxyl content cellulose ester, methods of preparation of hydroxyl content cellulose esters and the use of high hydroxyl content cellulose esters in liquid crystal displays.

### REFERENCE TO JOINT RESEARCH AGREEMENT

Eastman Chemical Company and APS Corporation were under a Joint Research Agreement in effect prior to the date the inventions were made and the inventions are a result of activities undertaken within the scope of the Joint Research Agreement.

### DISCUSSION OF THE BACKGROUND

The importance of cellulose esters in LCD applications is unquestioned. Cellulose esters are found ubiquitously in LCDs. The most common application of cellulose esters in LCDs is as a substrate or protective layer for polarizers. Cellulose ester-based substrates are used in several applications, most notably polarizers, but also wave plates, and compensation plates.

A liquid crystal display (LCD) is a relatively complicated electronic device. The performance requirements for LCDs change based on the target market. LCD televisions (TVs) must meet very high standards regarding viewing angle, contrast and color distortion. The “schematic representation of the elements of a generalized liquid crystal display” found in Kelly, S. M. “Flat Panel Displays: Advanced Organic Materials,” Royal Society of Chemistry, Cambridge, UK, 2000 describes the following layers: 1) mirror, 2) analyzer, 3) optical retarder, 4) rear substrate and electrode, 5) passivation layer, 6) alignment layer, 7) nematic layer (liquid crystal layer), 8) alignment layer, 9) passivation layer, 10) front substrate and electrode, 11) optical retarder, and 12) polarizer. Yeh described the following typical optical components of LCDs: 1) back light, 2) diffuser, 3) brightness enhancement film, 4) dual brightness enhancement film, 5) polarizer, 6) compensator film, 7) glass, 8) thin film transistor, 9) indium tin oxide electrode, 10) liquid crystal layer, 11) color filters (RGB), and 12) compensator film (Yeh, P. SID Short Course, S-2: Fundamentals of Display Optics, 2006). The descriptions above demonstrate the complex nature of liquid crystal displays (LCDs). The complex nature of LCDs provides several opportunities for improving the performance of the various layers and possibly combining layers using multifunctional polymers to reduce manufacturing costs by eliminating process steps and the costs of additional materials.

TAC film (triacetylcellulose film), also known as cellulose triacetate (CTA) film, provides a somewhat unique blend of properties, including desired water permeability levels, dimensional stability, optical clarity, and minimal birefringence values. Traditionally a cellulose triacetate film is prepared via a solvent-casting method, then surface treated to expose free hydroxyl groups to improve adhesion to a polyvinyl alcohol-based inner layer. Elimination of the additional surface treatment step would be advantageous to the manufacturer and could improve processing speed and eliminate yield loss due to faults in the film. TAC film is also used in compensation plate applications (WO 2006/016723, U.S. Pat. No. 7,084,944). Unstretched TAC provides very low levels of compensation and when TAC is used in a compensation application, complicated multi-layer systems or expensive additives, such as rod-like or discotic liquid crystalline compounds, are required to generate an acceptable level of compensation. Additionally, the uniaxial and biaxial stretching processes can lead to film flaws, particularly in the corners. Therefore, a cellulose ester-based polymer that could be used as both a substrate and a compensation film without uniaxial or biaxial stretching would be beneficial to both existing and new manufactures of LCD panels and components used in LCDs.

Conventional compositions of cellulose acetate propionate (CAP) (examples of conventional compositions of CAP include CAP-482-20 and CAP-141-20 and are commercially available from Eastman Chemical Company) are also used as substrates in various LCD applications. Conventional CAPs typically have improved solubility performance in non-halogenated solvents when compared to CTA (TAC). This provides environmental advantages to polarizer film, compensation film, and LCD manufacturers. Conventional CAP also suffers from many of the same disadvantages associated with TAC. Elimination of the complex processing and yield loss caused by film flaws introduced during the stretching processes are long sought after targets for technological advances.

Cellulose acetate butyrates (CABs) have been used as major film formers in compensation films and at additive levels, presumably to assist with flow and leveling, in the discotic or rod-like compound layers of compensations sheets and in wave plates.

To use cellulose esters in the LCD applications, complex processing steps are typically required and each of those steps produces opportunities for the introduction of errors or flaws in the films resulting in yield loss. The requirement of surface modification is another problem associated with the use of TAC or conventional CAP as substrates. Special care must be taken to control the processing of these materials.

There exists a need for a method of simplifying complicated systems and eliminating layers of LCDs. There exists a need for materials to overcome present limitations of certain cellulose esters used in LCD applications.

### BRIEF DESCRIPTION OF THE INVENTION

The present inventions provide methods of simplifying complicated systems and eliminating layers of LCDs. The present inventions provide materials, and methods for making the materials, useful to overcome certain present limitations of cellulose esters used in LCD applications. In one aspect the invention comprises a film comprising 70 to 100 weight percent of a cellulose acetate with a degree of substitution of hydroxyl groups from 0.40 to 2.00; 0 to 30 weight percent of a plasticizer; and 0 to 30 weight percent of an organic solvent, wherein the weight percent is based on the total weight of the cellulose acetate, the plasticizer and the organic solvent and wherein the film is unstretched.

In one aspect the invention relates to a film comprising 70 to 100 weight percent of a cellulose acetate propionate with a degree of substitution of hydroxyl groups from 0.40 to 2.00, a degree of substitution of acetyl groups of 0.01 to 2.59, and a degree of substitution of propionyl groups of 0.01 to 2.59, wherein the sum of the degrees of substitution of acetyl, propionyl, and hydroxyl groups equals 3.0; 0 to 30 weight percent of a plasticizer; and 0 to 30 weight percent of an organic solvent, wherein the weight percent is based on the total of the cellulose acetate propionate, the plasticizer and the organic solvent.

In one aspect the invention relates to a film comprising: 70 to 100 weight percent of a cellulose acetate propionate with a degree of substitution of hydroxyl groups from 0.65 to 2.00, a degree of substitution of acetyl groups of 0.01 to 2.34, and a degree of substitution of propionyl groups of 0.01 to 2.34, wherein the sum of the degrees of substitution of acetyl, propionyl, and hydroxyl groups equals 3.0; 0 to 30 weight percent of a plasticizer; and 0 to 30 weight percent of an organic solvent, wherein the weight percent is based on the total of the cellulose acetate propionate, the plasticizer and the organic solvent.

In one aspect the invention relates to a film comprising: 70 to 100 weight percent of a cellulose acetate propionate with a degree of substitution of hydroxyl groups from 0.95 to 2.00, a degree of substitution of acetyl groups of 0.01 to 2.04, and a degree of substitution of propionyl groups of 0.01 to 2.04, wherein the sum of the degrees of substitution of acetyl, propionyl, and hydroxyl groups equals 3.0; 0 to 30 weight percent of a plasticizer; and 0 to 30 weight percent of an organic solvent, wherein the weight percent is based on the total of the cellulose acetate propionate, the plasticizer and the organic solvent.

In one aspect the invention relates to a film comprising: 70 to 100 weight percent of a cellulose acetate propionate with a degree of substitution of hydroxyl groups from 1.01 to 2.00, a degree of substitution of acetyl groups of 0.01 to 1.99, and a degree of substitution of propionyl groups of 0.01 to 1.99, wherein the sum of the degrees of substitution of acetyl, propionyl, and hydroxyl groups equals 3.0; 0 to 30 weight percent of a plasticizer or a combination of plasticizers; and 0 to 30 weight percent of an organic solvent or blend of organic solvents, wherein the weight percent is based on the total of the cellulose acetate propionate, the plasticizer and the organic solvent.

In one aspect the invention relates to a film comprising: 70 to 100 weight percent of a cellulose acetate butyrate with a degree of substitution of hydroxyl groups from 0.40 to 2.00, a degree of substitution of acetyl groups of 0.01 to 2.59, and a degree of substitution of butyryl groups of 0.01 to 2.59, wherein the sum of the degrees of substitution of acetyl, butyryl, and hydroxyl groups equals 3.0; 0 to 30 weight percent of a plasticizer; and 0 to 30 weight percent of an organic solvent, wherein the weight percent is based on the total of the cellulose acetate butyrate, the plasticizer and the organic solvent.

In one aspect the invention relates to a film comprising: 70 to 100 weight percent of a cellulose acetate butyrate with a degree of substitution of hydroxyl groups from 0.65 to 2.00, a degree of substitution of acetyl groups of 0.01 to 2.34, and a degree of substitution of butyryl groups of 0.01 to 2.34, wherein the sum of the degrees of substitution of acetyl, butyryl, and hydroxyl groups equals 3.0; 0 to 30 weight percent of a plasticizer; and 0 to 30 weight percent of an organic solvent, wherein the weight percent is based on the total of the cellulose acetate butyrate, the plasticizer and the organic solvent.

In one aspect the invention relates to a film comprising: 70 to 100 weight percent of a cellulose acetate butyrate with a degree of substitution of hydroxyl groups from 0.95 to 2.00, a degree of substitution of acetyl groups of 0.01 to 2.04, and a degree of substitution of butyryl groups of 0.01 to 2.04, wherein the sum of the degrees of substitution of acetyl, butyryl, and hydroxyl groups equals 3.0; 0 to 30 weight percent of a plasticizer; and 0 to 30 weight percent of an organic solvent, wherein the weight percent is based on the total of the cellulose acetate butyrate, the plasticizer and the organic solvent.

In one aspect the invention relates to a film comprising: 70 to 100 weight percent of a cellulose acetate butyrate with a degree of substitution of hydroxyl groups from 1.01 to 2.00, a degree of substitution of acetyl groups of 0.01 to 1.99, and a degree of substitution of butyryl groups of 0.01 to 1.99, wherein the sum of the degrees of substitution of acetyl, butyryl, and hydroxyl groups equals 3.0; 0 to 30 weight percent of a plasticizer; and 0 to 30 weight percent of an organic solvent, wherein the weight percent is based on the total of the cellulose acetate butyrate, the plasticizer and the organic solvent.

In one aspect the invention relates to a film comprising: 70 to 100 weight percent of a cellulose acetate with a degree of substitution of hydroxyl groups from greater than 1.23 to 2.00; 0 to 30 weight percent of a plasticizer; and 0 to 30 weight percent of an organic solvent, wherein the weight percent is based on the total weight of the cellulose acetate, the plasticizer and the organic solvent and wherein the film is stretched.

Cellulose esters, for example but not limited to cellulose acetate (CA), cellulose acetate propionate (CAP), and cellulose acetate butyrate (CAB) with high degree of substitution of hydroxyl groups, that is DS_{OH} between about 0.40 and about 2.0 and from about 1.01 to about 2.0 are described. The use of high hydroxyl cellulose esters (high degree of substitution of hydroxyl groups or high DS_{OH}) in liquid crystal displays (LCDS) is described. We have discovered that as DS_{OH} goes up, the birefringence of the film at 633 nm, Δn⁶³³, goes down (that is, becomes more negative) for conventional cellulose esters. Conventional cellulose esters are described as commercially available C2-C4 aliphatic acid esters of cellulose, for example, including, but not limited to, cellulose acetate (CA), cellulose acetate propionate (CAP), and cellulose acetate butyrate (CAB). One embodiment of the invention discloses cellulose ester compositions that provide compensation to an LCD. Another embodiment of the invention discloses cellulose ester compositions that provide compensation to an LCD without biaxial stretching. One embodiment of the high DS_{OH} cellulose ester is useful in films that are stretched (uniaxially or biaxially) to enhance their compensation performance. Further, these inventive films comprising the high DS_{OH} cellulose esters are useful substitutions for standard cellulose triacetate substrates that require surface modification. In certain embodiments, at standard thicknesses ranging from about 3 microns to 1000 microns, the high hydroxy cellulose esters as described herein can be used to serve two functions in LCDs. These compositions can act as a single layer compensation plate/substrate in an LCD. In certain embodiments according to the present invention, the advantage of this strategy is two-fold. First, in certain embodiments of the present invention, the thickness of the LCD could be reduced by eliminated layers made unnecessary by the multifunctionality of the high hydroxyl cellulose esters. Second, in some embodiments of the present invention, the cost structure can be improved since use of a multifunctional single layer film allows the elimination of a number of processing steps, associated capital, process control costs, and/or yield loss.

### BRIEF DESCRIPTION OF THE DRAWINGS

FIG. 1 is a graph of degree of substitution of hydroxyl versus birefringence examples 1-9 and comparative example 21 from Tables 2-5.

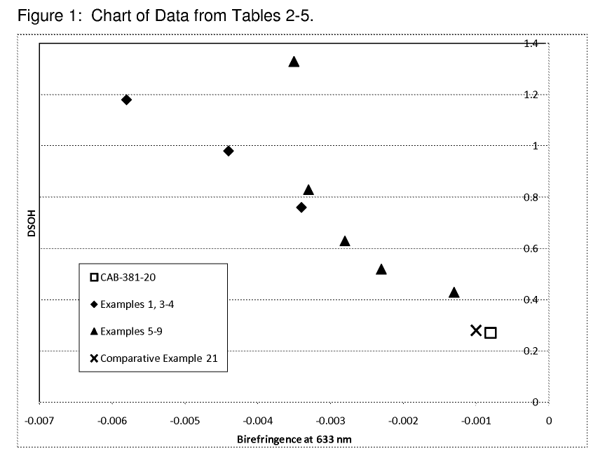

FIG. 2 is a graph of degree of substitution of hydroxyl versus birefringence for examples 10-16 and comparative examples 22-23 from Tables 2-5.

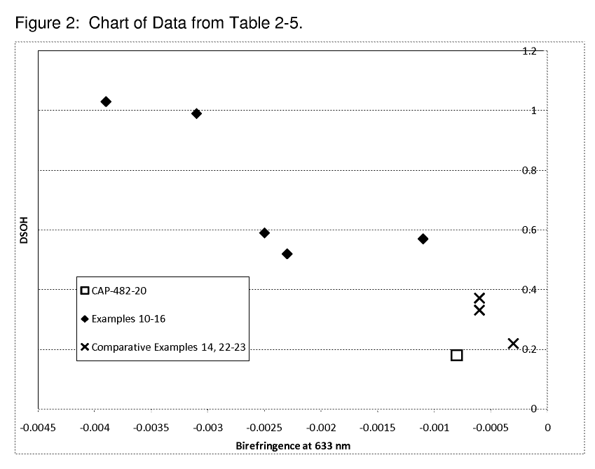

FIG. 3 is a graph of calculated retardance versus film thickness for examples 1, 3, and 4 and CAB-381-20 from Table 6.

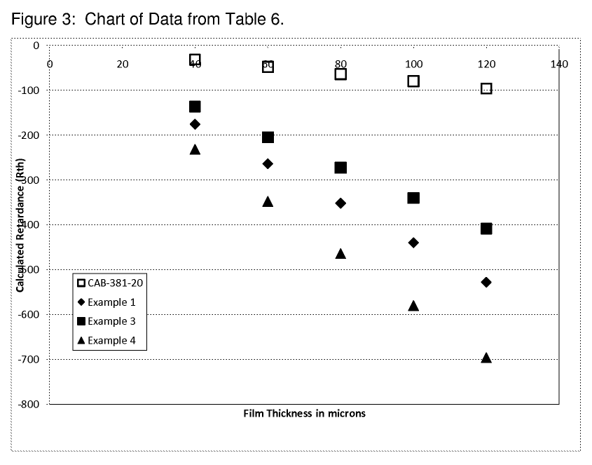

FIG. 4 is a graph of calculated retardance versus film thickness for examples 11 and 24, comparative example 22, and CAP-482-20 from Table 6.

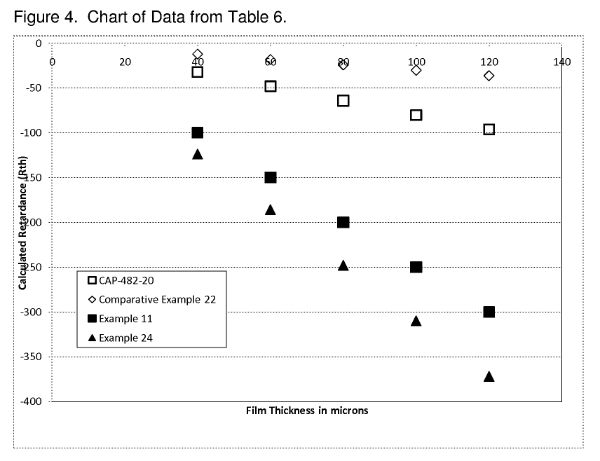

### DETAILED DESCRIPTION OF THE INVENTION

The present invention may be understood more readily by reference to the following detailed description of the invention, and to the Examples included therein.

Before the present compositions of matter and methods are disclosed and described, it is to be understood that this invention is not limited to specific synthetic methods or to particular formulations, unless otherwise indicated, and, as such, may vary from the disclosure. It is also to be understood that the terminology used is for the purpose of describing particular embodiments only, and is not intended to limit the scope of the invention.

Optional or optionally means that the subsequently described event or circumstances may or may not occur. The description includes instances where the event or circumstance occurs and instances where it does not occur.

Each numerical parameter should at least be construed in light of the number of reported significant digits and by applying ordinary rounding techniques. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.1113, etc., and the endpoints 0 and 10. Also, a range associated with chemical substituent groups such as, for example, “C₁ to C₅ hydrocarbons”, is intended to specifically include and disclose C₁ and C₅ hydrocarbons as well as C₂, C₃, and C₄ hydrocarbons.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

As used in the specification and the appended claims, the singular forms “a,” “an” and “the” include their plural referents unless the context clearly dictates otherwise. For example, reference a “film,” or a “polarizer,” is intended to include the processing or making of a plurality of films, or polarizers. References to a composition containing or including “an” additive or “a” catalyst is intended to include other ingredients or other additives or other catalysts, respectively, in addition to the one named.

By “comprising” or “containing” or “including” we mean that at least the named compound, element, particle, or method step, etc., is present in the composition or article or method, but does not exclude the presence of other compounds, catalysts, materials, particles, method steps, etc, even if the other such compounds, material, particles, method steps, etc., have the same function as what is named, unless expressly excluded in the claims.

It is also to be understood that the mention of one or more method steps does not preclude the presence of additional method steps before or after the combined recited steps or intervening method steps between those steps expressly identified. Moreover, the lettering of process steps or ingredients is a convenient means for identifying discrete activities or ingredients and the recited lettering can be arranged in any sequence, unless otherwise indicated.

Throughout this application, where patents or publications are referenced, the disclosures of these references in their entireties are intended to be incorporated by reference into this application, to the extent they are not inconsistent with the present invention, in order to more fully describe the state of the art to which the invention pertains.

As used herein, CAB means a cellulose acetate butyrate; CAP means a cellulose acetate propionate; CA means a cellulose acetate; CTA means cellulose triacetate; TAC means triacetylcellulose or cellulose triacetate; DS means degree of substitution of a specific substitutent on a cellulosic backbone on a mole basis assuming a maximum substitution level of 3.0 per anhydroglucose unit; DS_{Ac} means degree of substitution of acetyl esters; DS_{Pr} means degree of substitution of propionyl esters; DS_{Bu} means degree of substitution of butyryl esters; DS_{OH} means degree of substitution of hydroxyl groups which is the number of moles of unsubstituted positions per anhydroglucose unit of the cellulose backbone; DS_{Max} means the maximum degree of substitution, and is commonly accepted as equal to 3.0, but can be higher than that depending on the degree of polymerization of the cellulose ester; DS_{Ester} means the total degree of substitution of ester substituents on a cellulose ester; CE means cellulose ester; GPC means gel permeation chromatography; DSC means differential scanning calorimetry; T_{g} means glass transition temperature in degrees Celsius; Mₙ means number average molecular weight as determined by gel permeation chromatography; M_{w} means weight average molecular weight as determined by gel permeation chromatography; M_{w}/Mₙ means polydispersity as determined by gel permeation chromatography; Δn⁶³³ means the birefringence at 633 nanometers; IV means inherent viscosity; LCD means liquid crystal display; C-plate means a compensation film that is isotropic in the x-y plane where the z-direction represents the film thickness direction; positive C-plate means a compensation film that is isotropic in the x-y direction and nₓ=n_{y}<n_{z} where the z-direction represents the film thickness direction; negative C-plate means a compensation film that is isotropic in the x-y direction and nₓ=n_{y}>n_{z} where the z-direction represents the film thickness direction; A-plate means a compensation film that is isotropic in the y-z direction where the z-direction represents the film thickness direction; positive A-plate means a compensation film that is isotropic in the y-z direction and nₓ>n_{y}=n_{z} where the z-direction represents the film thickness direction; negative A-plate means a compensation film that is isotropic in the y-z direction and nₓ<n_{y}=n_{z} where the z-direction represents the film thickness direction; O plate means a compensation film that has its molecular axis tilted at an oblique angle; TN means twisted nematic; TN-LCD means a liquid crystal display based on a twisted nematic liquid crystal cell; STN means super-twisted nematic; STN-LCD means a liquid crystal display based on a super-twisted nematic liquid crystal cell; VA means vertically aligned; VA-LCD means a liquid crystal display based on a vertically aligned liquid crystal cell; biaxially stretched film means a polymeric film that is stretched in both the x and y axes; IPS means in-plane switching; IPS-LCD means a liquid crystal display based on an in-plane switching liquid crystal cell; OCB means optically compensated bend; OCB-LCD means a liquid crystal display based on an optically compensated bend liquid crystal cell; HAN means hybrid aligned nematic; HAN-LCD means a liquid crystal display based on a hybrid aligned nematic liquid crystal cell; Rₒ and Rₑ are both used to mean in-plane retardation; Rₜₕ and Rₜ are both used to mean out-of plane retardation. The term “acyl radical” refers to the portion of a carboxylic acid incorporated into an ester during the reaction of a hydroxyl group of a cellulose compound with a carboxylic acid. Planar stretch means stretching a film in the machine direction while constraining the film in the transverse direction to prevent the film from bowing or stretching a film in the transverse direction while constraining the film in the machine direction to prevent the film from bowing.

In certain embodiments according to the present invention, the cellulose esters comprise C2-C7 alkanoate esters or C2-C4 alkanoate esters. Examples of desirable cellulose esters include, but are not limited to cellulose acetate (CA), cellulose acetate propionate (CAP), cellulose acetate butyrate (CAB), cellulose acetate propionate butyrate (CAPB), cellulose acetate isobutyrate (CAiBu), cellulose propionate butyrate (CPB), cellulose acetate valerate (CAV), cellulose acetate hexanoate (CAHex), and cellulose acetate heptanoate (CAHep) with high degree of substitution of hydroxyl groups, preferably DS_{OH} between about 0.5 and about 2.0, and DS_{OH} between about 0.75 to about 2.0; and DS_{OH} between about 1.01 and about 2.00, and a DS_{OH} between about 1.01 and about 1.75.

In certain embodiments of the present invention, the lower range of DS_{OH}

is 0.4 or 0.5 or 0.6 or 0.65 or 0.7 or 0.8 or 0.9 or 0.95 or 1.0 or 1.01 or 1.1 or 1.2 or greater than 1.23 or 1.25 or 1.3 or 1.4, or 1.5 or 1.6 or 1.7 or 1.8 or 1.9. In certain embodiments of the present invention, the upper range of DS_{OH} is 0.5 or 0.6 or 0.65 or 0.7 or 0.8 or 0.9 or 0.95 or 1.0 or 1.01 or 1.1 or 1.2 or greater than 1.23 or 1.25 or 1.3 or 1.4, or 1.5 or 1.6 or 1.7 or 1.8 or 1.9 or 2.0. Any lower range DS_{OH} may be combined with any upper range of DS_{OH}.

In other embodiments according to the present invention the DS_{OH} may range from 0.4 to 0.5 or 0.4 to 0.6 or 0.4 to 0.65 or 0.4 to 0.7 or 0.4 to 0.8 or 0.4 to 0.9 or 0.4 to 0.95 or 0.4 to 1.0 or 0.4 to 1.01 or 0.4 to 1.1 or 0.4 to 1.2 or 0.4 to greater than 1.23 or 0.4 to 1.25 or 0.4 to 1.3 or 0.4 to 1.4 or 0.4 to 1.5 or 0.4 to 1.6 or 0.4 to 1.7 or 0.4 to 1.8 or 0.4 to 1.9 or 0.4 to 2.0 or 0.5 to 0.6 or 0.5 to 0.65 or 0.5 to 0.7 or 0.5 to 0.8 or 0.5 to 0.9 or 0.5 to 0.95 or 0.5 to 1.0 or 0.5 to 1.01 or 0.5 to 1.1 or 0.5 to 1.2 or 0.5 to greater than 1.23 or 0.5 to 1.25 or 0.5 to 1.3 or 0.5 to 1.4 or 0.5 to 1.5 or 0.5 to 1.6 or 0.5 to 1.7 or 0.5 to 1.8 or 0.5 to 1.9 or 0.5 to 2.0 or 0.6 to 0.65 or 0.6 to 0.7 or 0.6 to 0.8 or 0.6 to 0.9 or 0.6 to 0.95 or 0.6 to 1.0 or 0.6 to 1.01 or 0.6 to 1.1 or 0.6 to 1.2 or 0.6 to greater than 1.23 or 0.6 to 1.25 or 0.6 to 1.3 or 0.6 to 1.4 or 0.6 to 1.5 or 0.6 to 1.6 or 0.6 to 1.7 or 0.6 to 1.8 or 0.6 to 1.9 or 0.6 to 2.0 or 0.65 to 0.7 or 0.65 to 0.8 or 0.65 to 0.9 or 0.65 to 0.95 or 0.65 to 1.0 or 0.65 to 1.01 or 0.65 to 1.1 or 0.65 to 1.2 or 0.65 to greater than 1.23 or 0.65 to 1.25 or 0.65 to 1.3 or 0.65 to 1.4 or 0.65 to 1.5 or 0.65 to 1.6 or 0.65 to 1.7 or 0.65 to 1.8 or 0.65 to 1.9 or 0.65 to 2.0 or 0.7 to 0.8 or 0.7 to 0.9 or 0.7 to 0.95 or 0.7 to 1.0 or 0.7 to 1.01 or 0.7 to 1.1 or 0.7 to 1.2 or 0.7 to greater than 1.23 or 0.7 to 1.25 or 0.7 to 1.3 or 0.7 to 1.4 or 0.7 to 1.5 or 0.7 to 1.6 or 0.7 to 1.7 or 0.7 to 1.8 or 0.7 to 1.9 or 0.7 to 2.0 or 0.8 to 0.9 or 0.8 to 0.95 or 0.8 to 1.0 or 0.8 to 1.01 or 0.8 to 1.1 or 0.8 to 1.2 or 0.8 to greater than 1.23 or 0.8 to 1.25 or 0.8 to 1.3 or 0.8 to 1.4 or 0.8 to 1.5 or 0.8 to 1.6 or 0.8 to 1.7 or 0.8 to 1.8 or 0.8 to 1.9 or 0.8 to 2.0 or 0.9 to 0.95 or 0.9 to 1.0 or 0.9 to 1.01 or 0.9 to 1.1 or 0.9 to 1.2 or 0.9 to greater than 1.23 or 0.9 to 1.25 or 0.9 to 1.3 or 0.9 to 1.4 or 0.9 to 1.5 or 0.9 to 1.6 or 0.9 to 1.7 or 0.9 to 1.8 or 0.9 to 1.9 or 0.9 to 2.0 or 0.95 to 1.0 or 0.95 to 1.01 or 0.95 to 1.1 or 0.95 to 1.2 or 0.95 to greater than 1.23 or 0.95 to 1.25 or 0.95 to 1.3 or 0.95 to 1.4 or 0.95 to 1.5 or 0.95 to 1.6 or 0.95 to 1.7 or 0.95 to 1.8 or 0.95 to 1.9 or 0.95 to 2.0 or 1.01 to 1.1 or 1.01 to 1.2 or 1.01 to greater than 1.23 or 1.01 to 1.25 or 1.01 to 1.3 or 1.01 to 1.4 or 1.01 to 1.5 or 1.01 to 1.6 or 1.01 to 1.7 or 1.01 to 1.8 or 1.01 to 1.9 or 1.01 to 2.0 or 1.1 to 1.2 or 1.1 to greater than 1.23 or 1.1 to 1.25 or 1.1 to 1.3 or 1.1 to 1.4 or 1.1 to 1.5 or 1.1 to 1.6 or 1.1 to 1.7 or 1.1 to 1.8 or 1.1 to 1.9 or 1.1 to 2.0 or 1.2 to greater than 1.23 or 1.2 to 1.25 or 1.2 to 1.3 or 1.2 to 1.4 or 1.2 to 1.5 or 1.2 to 1.6 or 1.2 to 1.7 or 1.2 to 1.8 or 1.2 to 1.9 or 1.2 to 2.0 or greater than 1.23 to 1.3 or greater than 1.23 to 1.4 or greater than 1.23 to 1.5 or greater than 1.23 to 1.6 or greater than 1.23 to 1.7 or greater than 1.23 to 1.8 or greater than 1.23 to 1.9 or greater than 1.23 to 2.0 or 1.3 to 1.4 or 1.3 to 1.5 or 1.3 to 1.6 or 1.3 to 1.7 or 1.3 to 1.8 or 1.3 to 1.9 or 1.3 to 2.0 or 1.4 to 1.5 or 1.4 to 1.6 or 1.4 to 1.7 or 1.4 to 1.8 or 1.4 to 1.9 or 1.4 to 2.0 or 1.5 to 1.6 or 1.5 to 1.7 or 1.5 to 1.8 or 1.5 to 1.9 or 1.5 to 2.0 or 1.6 to 1.7 or 1.6 to 1.8 or 1.6 to 1.9 or 1.6 to 2.0 or 1.7 to 1.8 or 1.7 to 1.9 or 1.7 to 2.0 or 1.8 to 1.9 or 1.8 to 2.0 or 1.9 to 2.0.

In other embodiments according to the present invention the cellulose ester comprises a cellulose acetate with a maximum degree of substitution (DS_{Max}) of 3.0 wherein DS_{OH} may range from 0.4 to 0.5 or 0.4 to 0.6 or 0.4 to 0.65 or 0.4 to 0.7 or 0.4 to 0.8 or 0.4 to 0.9 or 0.4 to 0.95 or 0.4 to 1.0 or 0.4 to 1.01 or 0.4 to 1.1 or 0.4 to 1.2 or 0.4 to greater than 1.23 or 0.4 to 1.25 or 0.4 to 1.3 or 0.4 to 1.4 or 0.4 to 1.5 or 0.4 to 1.6 or 0.4 to 1.7 or 0.4 to 1.8 or 0.4 to 1.9 or 0.4 to 2.0 or 0.5 to 0.6 or 0.5 to 0.65 or 0.5 to 0.7 or 0.5 to 0.8 or 0.5 to 0.9 or 0.5 to 0.95 or 0.5 to 1.0 or 0.5 to 1.01 or 0.5 to 1.1 or 0.5 to 1.2 or 0.5 to greater than 1.23 or 0.5 to 1.25 or 0.5 to 1.3 or 0.5 to 1.4 or 0.5 to 1.5 or 0.5 to 1.6 or 0.5 to 1.7 or 0.5 to 1.8 or 0.5 to 1.9 or 0.5 to 2.0 or 0.6 to 0.65 or 0.6 to 0.7 or 0.6 to 0.8 or 0.6 to 0.9 or 0.6 to 0.95 or 0.6 to 1.0 or 0.6 to 1.01 or 0.6 to 1.1 or 0.6 to 1.2 or 0.6 to greater than 1.23 or 0.6 to 1.25 or 0.6 to 1.3 or 0.6 to 1.4 or 0.6 to 1.5 or 0.6 to 1.6 or 0.6 to 1.7 or 0.6 to 1.8 or 0.6 to 1.9 or 0.6 to 2.0 or 0.65 to 0.7 or 0.65 to 0.8 or 0.65 to 0.9 or 0.65 to 0.95 or 0.65 to 1.0 or 0.65 to 1.01 or 0.65 to 1.1 or 0.65 to 1.2 or 0.65 to greater than 1.23 or 0.65 to 1.25 or 0.65 to 1.3 or 0.65 to 1.4 or 0.65 to 1.5 or 0.65 to 1.6 or 0.65 to 1.7 or 0.65 to 1.8 or 0.65 to 1.9 or 0.65 to 2.0 or 0.7 to 0.8 or 0.7 to 0.9 or 0.7 to 0.95 or 0.7 to 1.0 or 0.7 to 1.01 or 0.7 to 1.1 or 0.7 to 1.2 or 0.7 to greater than 1.23 or 0.7 to 1.25 or 0.7 to 1.3 or 0.7 to 1.4 or 0.7 to 1.5 or 0.7 to 1.6 or 0.7 to 1.7 or 0.7 to 1.8 or 0.7 to 1.9 or 0.7 to 2.0 or 0.8 to 0.9 or 0.8 to 0.95 or 0.8 to 1.0 or 0.8 to 1.01 or 0.8 to 1.1 or 0.8 to 1.2 or 0.8 to greater than 1.23 or 0.8 to 1.25 or 0.8 to 1.3 or 0.8 to 1.4 or 0.8 to 1.5 or 0.8 to 1.6 or 0.8 to 1.7 or 0.8 to 1.8 or 0.8 to 1.9 or 0.8 to 2.0 or 0.9 to 0.95 or 0.9 to 1.0 or 0.9 to 1.01 or 0.9 to 1.1 or 0.9 to 1.2 or 0.9 to greater than 1.23 or 0.9 to 1.25 or 0.9 to 1.3 or 0.9 to 1.4 or 0.9 to 1.5 or 0.9 to 1.6 or 0.9 to 1.7 or 0.9 to 1.8 or 0.9 to 1.9 or 0.9 to 2.0 or 0.95 to 1.0 or 0.95 to 1.01 or 0.95 to 1.1 or 0.95 to 1.2 or 0.95 to greater than 1.23 or 0.95 to 1.25 or 0.95 to 1.3 or 0.95 to 1.4 or 0.95 to 1.5 or 0.95 to 1.6 or 0.95 to 1.7 or 0.95 to 1.8 or 0.95 to 1.9 or 0.95 to 2.0 or 1.01 to 1.1 or 1.01 to 1.2 or 1.01 to greater than 1.23 or 1.01 to 1.25 or 1.01 to 1.3 or 1.01 to 1.4 or 1.01 to 1.5 or 1.01 to 1.6 or 1.01 to 1.7 or 1.01 to 1.8 or 1.01 to 1.9 or 1.01 to 2.0 or 1.1 to 1.2 or 1.1 to greater than 1.23 or 1.1 to 1.25 or 1.1 to 1.3 or 1.1 to 1.4 or 1.1 to 1.5 or 1.1 to 1.6 or 1.1 to 1.7 or 1.1 to 1.8 or 1.1 to 1.9 or 1.1 to 2.0 or 1.2 to greater than 1.23 or 1.2 to 1.25 or 1.2 to 1.3 or 1.2 to 1.4 or 1.2 to 1.5 or 1.2 to 1.6 or 1.2 to 1.7 or 1.2 to 1.8 or 1.2 to 1.9 or 1.2 to 2.0 or greater than 1.23 to 1.3 or greater than 1.23 to 1.4 or greater than 1.23 to 1.5 or greater than 1.23 to 1.6 or greater than 1.23 to 1.7 or greater than 1.23 to 1.8 or greater than 1.23 to 1.9 or greater than 1.23 to 2.0 or 1.3 to 1.4 or 1.3 to 1.5 or 1.3 to 1.6 or 1.3 to 1.7 or 1.3 to 1.8 or 1.3 to 1.9 or 1.3 to 2.0 or 1.4 to 1.5 or 1.4 to 1.6 or 1.4 to 1.7 or 1.4 to 1.8 or 1.4 to 1.9 or 1.4 to 2.0 or 1.5 to 1.6 or 1.5 to 1.7 or 1.5 to 1.8 or 1.5 to 1.9 or 1.5 to 2.0 or 1.6 to 1.7 or 1.6 to 1.8 or 1.6 to 1.9 or 1.6 to 2.0 or 1.7 to 1.8 or 1.7 to 1.9 or 1.7 to 2.0 or 1.8 to 1.9 or 1.8 to 2.0 or 1.9 to 2.0 and the ranges of DS_{Ac} are determined according to equation 1 below.

DS_{Ac}=DS_{Max}−DS_{OH} Equation 1

One example shows that when DS_{OH} ranges between for example 0.4 to 0.5, then DS_{Ac} ranges between 2.5 and 2.6 as determined by the following calculations:

DS_{Ac}=3.0−0.4=2.6

DS_{Ac}=3.0−0.5=2.5

In other embodiments according to the present invention the cellulose ester comprises a cellulose acetate propionate with a maximum degree of substitution (DS_{Max}) of 3.0 where DS_{OH} may range from 0.4 to 0.5 or 0.4 to 0.6 or 0.4 to 0.65 or 0.4 to 0.7 or 0.4 to 0.8 or 0.4 to 0.9 or 0.4 to 0.95 or 0.4 to 1.0 or 0.4 to 1.01 or 0.4 to 1.1 or 0.4 to 1.2 or 0.4 to greater than 1.23 or 0.4 to 1.25 or 0.4 to 1.3 or 0.4 to 1.4 or 0.4 to 1.5 or 0.4 to 1.6 or 0.4 to 1.7 or 0.4 to 1.8 or 0.4 to 1.9 or 0.4 to 2.0 or 0.5 to 0.6 or 0.5 to 0.65 or 0.5 to 0.7 or 0.5 to 0.8 or 0.5 to 0.9 or 0.5 to 0.95 or 0.5 to 1.0 or 0.5 to 1.01 or 0.5 to 1.1 or 0.5 to 1.2 or 0.5 to greater than 1.23 or 0.5 to 1.25 or 0.5 to 1.3 or 0.5 to 1.4 or 0.5 to 1.5 or 0.5 to 1.6 or 0.5 to 1.7 or 0.5 to 1.8 or 0.5 to 1.9 or 0.5 to 2.0 or 0.6 to 0.65 or 0.6 to 0.7 or 0.6 to 0.8 or 0.6 to 0.9 or 0.6 to 0.95 or 0.6 to 1.0 or 0.6 to 1.01 or 0.6 to 1.1 or 0.6 to 1.2 or 0.6 to greater than 1.23 or 0.6 to 1.25 or 0.6 to 1.3 or 0.6 to 1.4 or 0.6 to 1.5 or 0.6 to 1.6 or 0.6 to 1.7 or 0.6 to 1.8 or 0.6 to 1.9 or 0.6 to 2.0 or 0.65 to 0.7 or 0.65 to 0.8 or 0.65 to 0.9 or 0.65 to 0.95 or 0.65 to 1.0 or 0.65 to 1.01 or 0.65 to 1.1 or 0.65 to 1.2 or 0.65 to greater than 1.23 or 0.65 to 1.25 or 0.65 to 1.3 or 0.65 to 1.4 or 0.65 to 1.5 or 0.65 to 1.6 or 0.65 to 1.7 or 0.65 to 1.8 or 0.65 to 1.9 or 0.65 to 2.0 or 0.7 to 0.8 or 0.7 to 0.9 or 0.7 to 0.95 or 0.7 to 1.0 or 0.7 to 1.01 or 0.7 to 1.1 or 0.7 to 1.2 or 0.7 to greater than 1.23 or 0.7 to 1.25 or 0.7 to 1.3 or 0.7 to 1.4 or 0.7 to 1.5 or 0.7 to 1.6 or 0.7 to 1.7 or 0.7 to 1.8 or 0.7 to 1.9 or 0.7 to 2.0 or 0.8 to 0.9 or 0.8 to 0.95 or 0.8 to 1.0 or 0.8 to 1.01 or 0.8 to 1.1 or 0.8 to 1.2 or 0.8 to greater than 1.23 or 0.8 to 1.25 or 0.8 to 1.3 or 0.8 to 1.4 or 0.8 to 1.5 or 0.8 to 1.6 or 0.8 to 1.7 or 0.8 to 1.8 or 0.8 to 1.9 or 0.8 to 2.0 or 0.9 to 0.95 or 0.9 to 1.0 or 0.9 to 1.01 or 0.9 to 1.1 or 0.9 to 1.2 or 0.9 to greater than 1.23 or 0.9 to 1.25 or 0.9 to 1.3 or 0.9 to 1.4 or 0.9 to 1.5 or 0.9 to 1.6 or 0.9 to 1.7 or 0.9 to 1.8 or 0.9 to 1.9 or 0.9 to 2.0 or 0.95 to 1.0 or 0.95 to 1.01 or 0.95 to 1.1 or 0.95 to 1.2 or 0.95 to greater than 1.23 or 0.95 to 1.25 or 0.95 to 1.3 or 0.95 to 1.4 or 0.95 to 1.5 or 0.95 to 1.6 or 0.95 to 1.7 or 0.95 to 1.8 or 0.95 to 1.9 or 0.95 to 2.0 or 1.01 to 1.1 or 1.01 to 1.2 or 1.01 to greater than 1.23 or 1.01 to 1.25 or 1.01 to 1.3 or 1.01 to 1.4 or 1.01 to 1.5 or 1.01 to 1.6 or 1.01 to 1.7 or 1.01 to 1.8 or 1.01 to 1.9 or 1.01 to 2.0 or 1.1 to 1.2 or 1.1 to greater than 1.23 or 1.1 to 1.25 or 1.1 to 1.3 or 1.1 to 1.4 or 1.1 to 1.5 or 1.1 to 1.6 or 1.1 to 1.7 or 1.1 to 1.8 or 1.1 to 1.9 or 1.1 to 2.0 or 1.2 to greater than 1.23 or 1.2 to 1.25 or 1.2 to 1.3 or 1.2 to 1.4 or 1.2 to 1.5 or 1.2 to 1.6 or 1.2 to 1.7 or 1.2 to 1.8 or 1.2 to 1.9 or 1.2 to 2.0 or greater than 1.23 to 1.3 or greater than 1.23 to 1.4 or greater than 1.23 to 1.5 or greater than 1.23 to 1.6 or greater than 1.23 to 1.7 or greater than 1.23 to 1.8 or greater than 1.23 to 1.9 or greater than 1.23 to 2.0 or 1.3 to 1.4 or 1.3 to 1.5 or 1.3 to 1.6 or 1.3 to 1.7 or 1.3 to 1.8 or 1.3 to 1.9 or 1.3 to 2.0 or 1.4 to 1.5 or 1.4 to 1.6 or 1.4 to 1.7 or 1.4 to 1.8 or 1.4 to 1.9 or 1.4 to 2.0 or 1.5 to 1.6 or 1.5 to 1.7 or 1.5 to 1.8 or 1.5 to 1.9 or 1.5 to 2.0 or 1.6 to 1.7 or 1.6 to 1.8 or 1.6 to 1.9 or 1.6 to 2.0 or 1.7 to 1.8 or 1.7 to 1.9 or 1.7 to 2.0 or 1.8 to 1.9 or 1.8 to 2.0 or 1.9 to 2.0 and DS_{Ac} ranges from 0.1 to 0.25 or 0.25 to 0.5 or 0.5 to 0.75 or 0.75 to 1.0 or 1.0 to 1.25 or 1.25 to 1.5 or 1.5 to 1.75 or 1.75 to 2.0 or 2.0 to 2.25 or 2.25 to 2.5 and the range of DS_{Pr} is determined according to equation 2.

DS_{Pr}=DS_{Max}−DS_{Ac}−DS_{OH} Equation 2

One example shows that when DS_{OH} ranges between for example 0.4 to 0.5 and DS_{Ac} ranges from 0.1 and 0.25 and the range of DS_{Pr} ranges from 2.25 to 2.5 as determined by calculating the four possible DS_{Pr} values and selecting the two extremes of the four numbers, and in this example the following DS_{Pr} values are possible:

DS_{Pr}=3.0−0.4−0.1=2.5

DS_{Pr}=3.0−0.4−0.25=2.35

DS_{Pr}=3.0−0.5−0.1=2.4

DS_{Pr}=3.0−0.5−0.25=2.25.

In other embodiments according to the present invention the cellulose ester comprises a cellulose acetate butyrate with a maximum degree of substitution (DS_{Max}) of 3.0 where DS_{OH} may range from 0.4 to 0.5 or 0.4 to 0.6 or 0.4 to 0.65 or 0.4 to 0.7 or 0.4 to 0.8 or 0.4 to 0.9 or 0.4 to 0.95 or 0.4 to 1.0 or 0.4 to 1.01 or 0.4 to 1.1 or 0.4 to 1.2 or 0.4 to greater than 1.23 or 0.4 to 1.25 or 0.4 to 1.3 or 0.4 to 1.4 or 0.4 to 1.5 or 0.4 to 1.6 or 0.4 to 1.7 or 0.4 to 1.8 or 0.4 to 1.9 or 0.4 to 2.0 or 0.5 to 0.6 or 0.5 to 0.65 or 0.5 to 0.7 or 0.5 to 0.8 or 0.5 to 0.9 or 0.5 to 0.95 or 0.5 to 1.0 or 0.5 to 1.01 or 0.5 to 1.1 or 0.5 to 1.2 or 0.5 to greater than 1.23 or 0.5 to 1.25 or 0.5 to 1.3 or 0.5 to 1.4 or 0.5 to 1.5 or 0.5 to 1.6 or 0.5 to 1.7 or 0.5 to 1.8 or 0.5 to 1.9 or 0.5 to 2.0 or 0.6 to 0.65 or 0.6 to 0.7 or 0.6 to 0.8 or 0.6 to 0.9 or 0.6 to 0.95 or 0.6 to 1.0 or 0.6 to 1.01 or 0.6 to 1.1 or 0.6 to 1.2 or 0.6 to greater than 1.23 or 0.6 to 1.25 or 0.6 to 1.3 or 0.6 to 1.4 or 0.6 to 1.5 or 0.6 to 1.6 or 0.6 to 1.7 or 0.6 to 1.8 or 0.6 to 1.9 or 0.6 to 2.0 or 0.65 to 0.7 or 0.65 to 0.8 or 0.65 to 0.9 or 0.65 to 0.95 or 0.65 to 1.0 or 0.65 to 1.01 or 0.65 to 1.1 or 0.65 to 1.2 or 0.65 to greater than 1.23 or 0.65 to 1.25 or 0.65 to 1.3 or 0.65 to 1.4 or 0.65 to 1.5 or 0.65 to 1.6 or 0.65 to 1.7 or 0.65 to 1.8 or 0.65 to 1.9 or 0.65 to 2.0 or 0.7 to 0.8 or 0.7 to 0.9 or 0.7 to 0.95 or 0.7 to 1.0 or 0.7 to 1.01 or 0.7 to 1.1 or 0.7 to 1.2 or 0.7 to greater than 1.23 or 0.7 to 1.25 or 0.7 to 1.3 or 0.7 to 1.4 or 0.7 to 1.5 or 0.7 to 1.6 or 0.7 to 1.7 or 0.7 to 1.8 or 0.7 to 1.9 or 0.7 to 2.0 or 0.8 to 0.9 or 0.8 to 0.95 or 0.8 to 1.0 or 0.8 to 1.01 or 0.8 to 1.1 or 0.8 to 1.2 or 0.8 to greater than 1.23 or 0.8 to 1.25 or 0.8 to 1.3 or 0.8 to 1.4 or 0.8 to 1.5 or 0.8 to 1.6 or 0.8 to 1.7 or 0.8 to 1.8 or 0.8 to 1.9 or 0.8 to 2.0 or 0.9 to 0.95 or 0.9 to 1.0 or 0.9 to 1.01 or 0.9 to 1.1 or 0.9 to 1.2 or 0.9 to greater than 1.23 or 0.9 to 1.25 or 0.9 to 1.3 or 0.9 to 1.4 or 0.9 to 1.5 or 0.9 to 1.6 or 0.9 to 1.7 or 0.9 to 1.8 or 0.9 to 1.9 or 0.9 to 2.0 or 0.95 to 1.0 or 0.95 to 1.01 or 0.95 to 1.1 or 0.95 to 1.2 or 0.95 to greater than 1.23 or 0.95 to 1.25 or 0.95 to 1.3 or 0.95 to 1.4 or 0.95 to 1.5 or 0.95 to 1.6 or 0.95 to 1.7 or 0.95 to 1.8 or 0.95 to 1.9 or 0.95 to 2.0 or 1.01 to 1.1 or 1.01 to 1.2 or 1.01 to greater than 1.23 or 1.01 to 1.25 or 1.01 to 1.3 or 1.01 to 1.4 or 1.01 to 1.5 or 1.01 to 1.6 or 1.01 to 1.7 or 1.01 to 1.8 or 1.01 to 1.9 or 1.01 to 2.0 or 1.1 to 1.2 or 1.1 to greater than 1.23 or 1.1 to 1.25 or 1.1 to 1.3 or 1.1 to 1.4 or 1.1 to 1.5 or 1.1 to 1.6 or 1.1 to 1.7 or 1.1 to 1.8 or 1.1 to 1.9 or 1.1 to 2.0 or 1.2 to greater than 1.23 or 1.2 to 1.25 or 1.2 to 1.3 or 1.2 to 1.4 or 1.2 to 1.5 or 1.2 to 1.6 or 1.2 to 1.7 or 1.2 to 1.8 or 1.2 to 1.9 or 1.2 to 2.0 or greater than 1.23 to 1.3 or greater than 1.23 to 1.4 or greater than 1.23 to 1.5 or greater than 1.23 to 1.6 or greater than 1.23 to 1.7 or greater than 1.23 to 1.8 or greater than 1.23 to 1.9 or greater than 1.23 to 2.0 or 1.3 to 1.4 or 1.3 to 1.5 or 1.3 to 1.6 or 1.3 to 1.7 or 1.3 to 1.8 or 1.3 to 1.9 or 1.3 to 2.0 or 1.4 to 1.5 or 1.4 to 1.6 or 1.4 to 1.7 or 1.4 to 1.8 or 1.4 to 1.9 or 1.4 to 2.0 or 1.5 to 1.6 or 1.5 to 1.7 or 1.5 to 1.8 or 1.5 to 1.9 or 1.5 to 2.0 or 1.6 to 1.7 or 1.6 to 1.8 or 1.6 to 1.9 or 1.6 to 2.0 or 1.7 to 1.8 or 1.7 to 1.9 or 1.7 to 2.0 or 1.8 to 1.9 or 1.8 to 2.0 or 1.9 to 2.0 and DS_{Ac} ranges from 0.1 to 0.25 or 0.25 to 0.5 or 0.5 to 0.75 or 0.75 to 1.0 or 1.0 to 1.25 or 1.25 to 1.5 or 1.5 to 1.75 or 1.75 to 2.0 or 2.0 to 2.25 or 2.25 to 2.5 and the range of DS_{Bu} is determined according to equation 3.

DS_{Bu}=DS_{Max}−DS_{Ac}−DS_{OH} Equation 3

One example shows that when DS_{OH} ranges between for example 0.4 to 0.5 and DS_{Ac} ranges from 0.1 and 0.25 and the range of DS_{Bu} ranges from 2.25 to 2.5 as determined by calculating the four possible DS_{Bu} values and selecting the two extremes of the four numbers, then the following DS_{Bu} values are possible:

DS_{Bu}=3.0−0.4−0.1=2.5

DS_{Bu}=3.0−0.4−0.25=2.35

DS_{Bu}=3.0−0.5−0.1=2.4

DS_{Bu}=3.0−0.5−0.25=2.25.

In certain embodiments according to the present invention, the birefringence at 633 nm is less than zero, or equal to or less than −0.001 or equal to or less than −0.002 or equal to or less than −0.003 or equal to or less than −0.004 or equal to or less than −0.005 or equal to or less than −0.006 or equal to or less than −0.007 or equal to or less than −0.008 or equal to or less than −0.009 or equal to or less than −0.010. When discussing a negative birefringence value, the term “less than” means a more negative value, for example less than

−0.005 could be −0.006, −0.007, −0.010, etc.

In other embodiments according to the present invention, the birefringence at 633 nm ranges from less than zero to −0.001 or less than zero to −0.002 or less than zero to −0.003 or less than zero to −0.004 less than zero to −0.005 or less than zero to −0.006 or less than zero to −0.007 or less than zero to −0.008 less than zero to −0.009 or less than zero to −0.010 or −0.001 to −0.002 or −0.001 to −0.003 or −0.001 to −0.004 or −0.001 to −0.005 or −0.001 to −0.006 or

−0.001 to −0.007 or −0.001 to −0.008 or −0.001 to −0.009 or −0.001 to −0.010 or
−0.002 to −0.003 or −0.002 to −0.004 or −0.002 to −0.005 or −0.002 to −0.006 or
−0.002 to −0.007 or −0.002 to −0.008 or −0.002 to −0.009 or −0.002 to −0.010 or
−0.003 to −0.004 or −0.003 to −0.005 or −0.003 to −0.006 or −0.003 to −0.007 or
−0.003 to −0.008 or −0.003 to −0.009 or −0.003 to −0.010 or −0.004 to −0.005 or
−0.004 to −0.006 or −0.004 to −0.007 or −0.004 to −0.008 or −0.004 to −0.009 or
−0.004 to −0.010 or −0.005 to −0.006 or −0.005 to −0.007 or −0.005 to −0.008 or
−0.005 to −0.009 or −0.005 to −0.010 or −0.006 to −0.007 or −0.006 to −0.008 or
−0.006 to −0.009 or −0.006 to −0.010 or −0.007 to −0.008 or −0.007 to −0.009 or
−0.007 to −0.010 or −0.008 to −0.009 or −0.008 to −0.010 or −0.900 to −0.010.

In certain embodiments according to the present invention, the number average molecular weight (Mₙ) of the cellulose ester ranges from 1,500 to 200,000. In certain embodiments the lower range of the Mₙ is 1,500 or 2,000 or 3,000 or 4,000 or 5,000 or 10,000 or 20,000 or 30,000 or 40,000 or 50,000 or 75,000 or 100,000 or 125,000 or 150,000 or 175,000 g/mol. In certain embodiments the upper range of the Mₙ of the cellulose ester is 2,000 or 3,000 or 4,000 or 5,000 or 10,000 or 20,000 or 30,000 or 40,000 or 50,000 or 75,000 or 100,000 or 125,000 or 150,000 or 175,000 or 200,000 g/mol. Any lower range of Mₙ may be combined with any upper range Of Mₙ.

In certain embodiments according to the present invention, the number average molecular weight (Mₙ) of the cellulose ester ranges may be 1,500 to 2,000 or 1,500 to 3,000 or 1,500 to 4,000 or 1,500 to 5,000 or 1,500 to 10,000 or 1,500 to 20,000 or 1,500 to 30,000 or 1,500 to 40,000 or 1,500 to 50,000 or 1,500 to 75,000 or 1,500 to 100,000 or 1,500 to 125,000 or 1,500 to 150,000 or 1,500 to 175,000 or 1,500 to 200,000 or 2,000 to 3,000 or 2,000 to 4,000 or 2,000 to 5,000 or 2,000 to 10,000 or 2,000 to 20,000 or 2,000 to 30,000 or 2,000 to 40,000 or 2,000 to 50,000 or 2,000 to 75,000 or 2,000 to 100,000 or 2,000 to 125,000 or 2,000 to 150,000 or 2,000 to 175,000 or 2,000 to 200,000 or 3,000 to 4,000 or 3,000 to 5,000 or 3,000 to 10,000 or 3,000 to 20,000 or 3,000 to 30,000 or 3,000 to 40,000 or 3,000 to 50,000 or 3,000 to 75,000 or 3,000 to 100,000 or 4,000 to 125,000 or 4,000 to 150,000 or 4,000 to 175,000 or 4,000 to 200,000 or 4,000 to 5,000 or 4,000 to 10,000 or 4,000 to 20,000 or 4,000 to 30,000 or 4,000 to 40,000 or 4,000 to 50,000 or 4,000 to 75,000 or 4,000 to 100,000 or 4,000 to 125,000 or 4,000 to 150,000 or 4,000 to 175,000 or 4,000 to 200,000 or 5,000 to 10,000 or 5,000 to 20,000 or 5,000 to 30,000 or 5,000 to 40,000 or 5,000 to 50,000 or 5,000 to 75,000 or 5,000 to 100,000 or 5,000 to 125,000 or 5,000 to 150,000 or 5,000 to 175,000 or 5,000 to 200,000 or 10,000 to 20,000 or 10,000 to 30,000 or 10,000 to 40,000 or 10,000 to 50,000 or 10,000 to 75,000 or 10,000 to 100,000 or 10,000 to 125,000 or 10,000 to 150,000 or 10,000 to 175,000 or 10,000 to 200,000 or 20,000 to 30,000 or 20,000 to 40,000 or 20,000 to 50,000 or 20,000 to 75,000 or 20,000 to 100,000 or 20,000 to 125,000 or 20,000 to 150,000 or 20,000 to 175,000 or 20,000 to 200,000 or 30,000 to 40,000 or 30,000 to 50,000 or 30,000 to 75,000 or 30,000 to 100,000 or 30,000 to 125,000 or 30,000 to 150,000 or 30,000 to 175,000 or 30,000 to 200,000 or 40,000 to 50,000 or 40,000 to 75,000 or 40,000 to 100,000 or 40,000 to 125,000 or 40,000 to 150,000 or 40,000 to 175,000 or 40,000 to 200,000 or 50,000 to 75,000 or 50,000 to 100,000 or 50,000 to 125,000 or 50,000 to 150,000 or 50,000 to 175,000 or 50,000 to 200,000 or 100,000 to 125,000 or 100,000 to 150,000 or 100,000 to 175,000 or 100,000 to 200,000 or 123,000 to 150,000 or 125,000 to 175,000 or 125,000 to 200,000 or 150,000 to 175,000 or 150,000 to 200,000 or 175,000 to 200,000 g/mol.

In certain embodiments according to the present invention, the inherent viscosity (IV) of the cellulose esters ranges from about 0.05 to about 3.0 deciliters/gram (dL/g). In some embodiments according to the present invention, the lower limit of IV is 0.05 or 0.10 or 0.15 or 0.20 or 0.25 or 0.30 or 0.35 or 0.40 or 0.45 or 0.50 or 0.55 or 0.60 or 0.65 or 0.70 or 0.75 or 0.80 or 0.85 or 0.90 or 0.95 or 1.00 or 1.10 or 1.20 or 1.30 or 1.40 or 1.50 or 1.60 or 1.70 or 1.80 or 1.90 or 2.00 or 2.10 or 2.20 or 2.30 or 2.40 or 2.50 or 2.60 or 2.70 or 2.80 or 2.90 dL/g. In some embodiments according to the present invention, the upper limit of IV is 0.10 or 0.15 or 0.20 or 0.25 or 0.30 or 0.35 or 0.40 or 0.45 or 0.50 or 0.55 or 0.60 or 0.65 or 0.70 or 0.75 or 0.80 or 0.85 or 0.90 or 0.95 or 1.00 or 1.10 or 1.20 or 1.30 or 1.40 or 1.50 or 1.60 or 1.70 or 1.80 or 1.90 or 2.00 or 2.10 or 2.20 or 2.30 or 2.40 or 2.50 or 2.60 or 2.70 or 2.80 or 2.90 or 3.00 dL/g. Any lower limit of IV may be combined with any upper limit of IV.

In one embodiment of the present invention, the use of high hydroxyl cellulose esters in liquid crystal displays (LCDs) is described. We have discovered that as DS_{OH} increases, the birefringence of the film at 633 nm, Δn⁶³³, becomes more negative for conventional cellulose esters. Conventional cellulose esters include C2-C7 aliphatic acid esters of cellulose for example, but are not limited to, cellulose acetate (CA), cellulose acetate propionate (CAP), and cellulose acetate butyrate (CAB). High DS_{OH} cellulose esters with a large negative Δn⁶³³, for example from about −0.002 to about −0.010, can thus be used as multifunctional layers in an LCD. High hydroxyl cellulose esters with large negative Δn⁶³³ can act as a single layer compensation plate/substrate in an LCD. A large negative Δn⁶³³ ranges from about −0.002 to about −0.010. The advantage of this strategy is two-fold. First, the thickness of the LCD could be reduced by eliminated layers made unnecessary by the multifunctionality of the high hydroxyl cellulose esters. Second, the cost structure can be improved since use of a multifunctional single layer film allows the elimination of a number of processing steps.

In one embodiment, the invention relates to a single layer film, prepared by solvent casting, comprising a cellulose ester comprising a C2-C7 acyl radical with a DS_{OH} of about 0.5 to about 2.00, preferably 0.75 to about 2.00, more preferably about 1.01 to about 2.00, and a Δn⁶³³<0.

In another embodiment, the invention relates to a single layer film, prepared by solvent casting, comprising a cellulose ester comprising a C2-C7 acyl radical with a DS_{OH} of about 0.5 to about 2.00, preferably 0.75 to about 2.00, more preferably about 1.01 to about 2.00, and Δn⁶³³ between about −0.002 and about −0.010.

In another embodiment, the invention relates to a single layer film, prepared by solvent casting, comprising a cellulose ester comprising a C2-C7 acyl radical with a DS_{OH} of about 0.5 to about 2.00, preferably 0.75 to about 2.00, more preferably about 1.01 to about 2.00, and Δn⁶³³ between about −0.003 and about −0.007.

In another embodiment, the invention relates to a single layer film comprising a cellulose ester comprising a C2-C7 acyl radical and having a degree of substitution of hydroxyl groups of about 0.5 to about 2.00 and a Δn⁶³³<0, and optionally comprising one or more plasticizers.

In another embodiment, the invention relates to a single layer film comprising a cellulose ester comprising a C2-C7 acyl radical and having a degree of substitution of hydroxyl groups of about 0.75 to about 1.75 and a Δn⁶³³<0, and optionally comprising one or more plasticizers.

In another embodiment, the invention relates to a single layer film comprising a cellulose ester comprising a C2-C7 acyl radical and having a degree of substitution of hydroxyl groups of about 1.01 to about 1.55 and a Δn⁶³³<0, and optionally comprising one or more plasticizers.

In another embodiment, the invention relates to a single layer film comprising a mixed cellulose ester comprising more than one C2-C7 acyl radical and having a degree of substitution of hydroxyl groups of about 0.5 to about 2.00 and a Δn⁶³³<0, and optionally comprising one or more plasticizers.

In another embodiment, the invention relates to a single layer film comprising a mixed cellulose ester substituted with more than one C2-C7 acyl radical and having a degree of substitution of hydroxyl groups of about 0.75 to about 1.75 and a Δn⁶³³<0, and optionally comprising one or more plasticizers.

In another embodiment, the invention relates to a single layer film comprising a mixed cellulose ester substituted with more than one C2-C7 acyl radical and having a degree of substitution of hydroxyl groups of about 1.01 to about 1.55 and a Δn⁶³³<0, and optionally comprising one or more plasticizers.

In another embodiment, the invention relates to a single layer film comprising cellulose acetate having a degree of substitution of hydroxyl groups of about 0.5 to about 2.00 and a Δn⁶³³<0, and optionally comprising one or more plasticizers.

In another embodiment, the invention relates to a single layer film comprising cellulose acetate having a degree of substitution of hydroxyl groups of about 0.75 to about 1.75 and a Δn⁶³³<0, and optionally comprising one or more plasticizers.

In another embodiment, the invention relates to a single layer film comprising cellulose acetate having a degree of substitution of hydroxyl groups of about 1.01 to about 1.55 and a Δn⁶³³<0, and optionally comprising one or more plasticizers.

In another embodiment, the invention relates to a single layer film comprising cellulose acetate propionate having a degree of substitution of hydroxyl groups of about 0.5 to about 2.00 and a Δn⁶³³<0, and optionally comprising one or more plasticizers.

In another embodiment, the invention relates to a single layer film comprising cellulose acetate propionate having a degree of substitution of hydroxyl groups of about 0.75 to about 1.75 and a Δn⁶³³<0, and optionally comprising one or more plasticizers.

In another embodiment, the invention relates to a single layer film comprising cellulose acetate propionate having a degree of substitution of hydroxyl groups of about 1.01 to about 1.55 and a Δn⁶³³<0, and optionally comprising one or more plasticizers.

In another embodiment, the invention relates to a single layer film comprising cellulose acetate butyrate having a degree of substitution of hydroxyl groups of about 0.5 to about 2.00 and a Δn⁶³³<0, and optionally comprising one or more plasticizers.

In another embodiment, the invention relates to a single layer film comprising cellulose acetate butyrate having a degree of substitution of hydroxyl groups of about 0.75 to about 1.75 and a Δn⁶³³<0, and optionally comprising one or more plasticizers.

In another embodiment, the invention relates to a single layer film comprising cellulose acetate butyrate having a degree of substitution of hydroxyl groups of about 1.01 to about 1.55 and a Δn⁶³³<0, and optionally comprising one or more plasticizers.

In another embodiment, the invention relates to a single layer film laminated onto another surface or surfaces, wherein the film comprises a cellulose ester substituted with a C2-C7 acyl radical and having a degree of substitution of hydroxyl groups of about 0.5 to about 2.00 and a Δn⁶³³<0, and optionally comprising one or more plasticizers.

In another embodiment, the invention relates to a single layer film laminated onto another surface or surfaces, wherein the film comprises a cellulose ester substituted with a C2-C7 acyl radical and having a degree of substitution of hydroxyl groups of about 0.75 to about 1.75 and a Δn⁶³³<0, and optionally comprising one or more plasticizers.

In another embodiment, the invention relates to a single layer film laminated onto another surface or surfaces, wherein the film comprises a cellulose ester substituted with a C2-C7 acyl radical and having a degree of substitution of hydroxyl groups of about 1.01 to about 1.55 and a Δn⁶³³<0, and optionally comprising one or more plasticizers.

In another embodiment, the invention relates to a single layer film laminated onto another surface or surfaces, wherein the film comprises a mixed cellulose ester substituted with more than one C2-C7 acyl radical and having a degree of substitution of hydroxyl groups of about 0.5 to about 2.00 and a Δn⁶³³<0, and optionally comprising one or more plasticizers.

In another embodiment, the invention relates to a single layer film laminated onto another surface or surfaces, wherein the film comprises a mixed cellulose ester substituted with more than one C2-C7 acyl radical and having a degree of substitution of hydroxyl groups of about 0.75 to about 1.75 and a Δn⁶³³<0, and optionally comprising one or more plasticizers.

In another embodiment, the invention relates to a single layer film laminated onto another surface or surfaces, wherein the film comprises a mixed cellulose ester substituted with more than one C2-C7 acyl radical and having a degree of substitution of hydroxyl groups of about 1.01 to about 1.55 and a Δn⁶³³<0, and optionally comprising one or more plasticizers.

In another embodiment, the invention relates to a single layer film laminated onto another surface or surfaces, wherein the single layer film comprises cellulose acetate having a degree of substitution of hydroxyl groups of about 0.5 to about 2.00 and a Δn⁶³³<0, and optionally comprising one or more plasticizers.

In another embodiment, the invention relates to a single layer film laminated onto another surface or surfaces, wherein the single layer film comprises cellulose acetate having a degree of substitution of hydroxyl groups of about 0.75 to about 1.75 and a Δn⁶³³<0, and optionally comprising one or more plasticizers.

In another embodiment, the invention relates to a single layer film laminated onto another surface or surfaces, wherein the single layer film comprises cellulose acetate having a degree of substitution of hydroxyl groups of about 1.01 to about 1.55 and a Δn⁶³³<0, and optionally comprising one or more plasticizers.

In another embodiment, the invention relates to a single layer film laminated onto another surface or surfaces, wherein the single layer film comprises cellulose acetate propionate having a degree of substitution of hydroxyl groups of about 0.5 to about 2.00 and a Δn⁶³³<0, and optionally comprising one or more plasticizers.

In another embodiment, the invention relates to a single layer film laminated onto another surface or surfaces, wherein the single layer film comprises cellulose acetate propionate having a degree of substitution of hydroxyl groups of about 0.75 to about 1.75 and a Δn⁶³³<0, and optionally comprising one or more plasticizers.

In another embodiment, the invention relates to a single layer film laminated onto another surface or surfaces, wherein the single layer film comprises cellulose acetate propionate having a degree of substitution of hydroxyl groups of about 1.01 to about 1.55 and a Δn⁶³³<0, and optionally comprising one or more plasticizers.

In another embodiment, the invention relates to a single layer film laminated onto another surface or surfaces, wherein the single layer film comprises cellulose acetate butyrate having a degree of substitution of hydroxyl groups of about 0.5 to about 2.00 and a Δn⁶³³<0, and optionally comprising one or more plasticizers.

In another embodiment, the invention relates to a single layer film laminated onto another surface or surfaces, wherein the single layer film comprises cellulose acetate butyrate having a degree of substitution of hydroxyl groups of about 0.75 to about 1.75 and a Δn⁶³³<0, and optionally comprising one or more plasticizers.

In another embodiment, the invention relates to a single layer film laminated onto another surface or surfaces, wherein the single layer film comprises cellulose acetate butyrate having a degree of substitution of hydroxyl groups of about 1.01 to about 1.55 and a Δn⁶³³<0, and optionally comprising one or more plasticizers.

In a further embodiment, the single layer films described above can be one component of a more complicated optical film sheet. For example the single layer sheets described above could be substrates for a polarizer.

In another embodiment, the single layer films described above can be laminated onto other films. For example the single layer sheets described above could be laminated onto the surface of an existing LCD component such as a liquid crystal cell or a polarizer.

In one embodiment the invention relates to a single layer film comprising a cellulose ester as described above and optionally one or more additional additives, for example plasticizers and/or organic solvents) as described above where the amount of compensation demonstrated by the film is controlled by the thickness of the film.

The film mentioned above can have thicknesses from about 3 microns to about 30 microns, or about 30 microns to about 80 microns, or about 80 microns to about 120 microns, or about 120 microns to about 300 microns, or the thickness is greater than 300 microns.

Examples of plasticizers include but are not limited to one or more of the following, phosphoric acid-based plasticizers, phthalic acid ester-based plasticizers, glycolate-based plasticizers, and citric acid ester-based plasticizers, carbohydrate ester-based plasticizers, and alditol ester-based plasticizers.

Examples of phosphoric acid ester-based plasticizers include but are not limited to triphenyl phosphate (TPP), tricresyl phosphate, cresyl phenyl phosphate, octyl diphenyl phosphate, diphenyl biphenyl phosphate, trioctyl phosphate, and tributyl phosphate. Phthalic acid ester-based plasticizers include but are not limited to diethyl phthalate, dimethoxyethyl phthalate, dimethyl phthalate, dioctyl phthalate, dibutyl phthalate, di-2-ethyl hexyl phthalate, butyl benzyl phthalate, di-2-ethylhexyl phthalate, butyl benzyl phthalate, and dibenzyl phthalate. Citric acid ester-based plasticizers include but are not limited to acetyl trimethyl citrate, and acetyl tributyl citrate. Glycolate-based plasticizers include but are not limited to alkyl phthalyl alkyl glycolate, such as methyl phthalyl methyl glycolate, ethyl phthalyl ethyl glycolate (EPEG), propyl phthalyl propyl glycolate, butyl phthalyl butyl glycolate, octyl phthalyl octyl glycolate, methyl phthalyl ethyl glycolate, ethyl phthalyl methyl glycolate, ethyl phthalyl propyl glycolate, propyl phthalyl ethyl glycolate, methyl phthalyl propyl glycolate, methyl phthalyl butyl glycolate, ethyl phthalyl butyl glycolate, butyl phthalyl methyl glycolate, butyl phthalyl ethyl glycolate, propyl phthalyl butyl glycolate, butyl phthalyl propyl glycolate, methyl phthalyl octyl glycolate, ethyl phthalyl octyl glycolate, octyl phthalyl methyl glycolate, and octyl phthalyl ethyl glycolate. Other useful plasticizers include, but are not limited to, butyl oleate, methyl acetyl ricinolate, dibutyl sebacate, and triacetin. Carbohydrate ester-based plasticizers include, but are not limited to, esters of 6-carbon aldose sugars, such as glucose pentapropionate, glucose pentaisobutyrate, and glucose pentatbutyrate; esters of 6-carbon ketose sugars such as fructose pentapropionate, fructose pentaisobutyrate, fructose pentatbutyrate; esters of 5-carbon aldose sugars, such as xylose tetrapropionate, xylose tetraisobutyrate, and xylose tetrabutryate. Alditol ester-based plasticizers incluse but are not limited to 5-carbon alditol esters, such as xylitol pentapropionate, xylitol pentaisobutryate, and xylitol pentabutyrate; 6-carbon alditol esters, such as mannitol hexapropionate, mannitol hexaisobutyrate, and mannitol hexabutyrate.

In another embodiment, the invention relates to a cellulose ester “dope” comprising a cellulose ester substituted with a C2-C7 acyl radical and having a degree of substitution of hydroxyl groups of about 0.5 to about 2.00 and a Δn⁶³³<0, and optionally comprising one or more plasticizers, and an organic solvent or blend of more than one organic solvent.

In another embodiment, the invention relates to a cellulose ester “dope” comprising a cellulose ester substituted with a C2-C7 acyl radical and having a degree of substitution of hydroxyl groups of about 0.5 to about 2.00 and a Δn⁶³³<0, and optionally comprising one or more plasticizers, and an organic solvent or blend of more than one organic solvent, wherein the cellulose ester comprises about 1 to about 50 wt % of the composition of the “dope,” and the plasticizer comprises about 0 to about 30 wt % of the composition of the “dope,” and the organic solvent or blend of organic solvents comprises from about 20 to about 99% of the composition of the “dope”.

In another embodiment, the invention relates to a cellulose ester “dope” comprising a cellulose ester substituted with a C2-C7 acyl radical and having a degree of substitution of hydroxyl groups of about 0.75 to about 1.75 and a Δn⁶³³<0, and optionally comprising one or more plasticizers, and an organic solvent or blend of more than one organic solvent, wherein the cellulose ester comprises about 1 to about 50 wt % of the composition of the “dope,” and the plasticizer comprises about 0 to about 30 wt % of the composition of the “dope,” and the organic solvent or blend of organic solvents comprises from about 20 to about 99% of the composition of the “dope”.

In another embodiment, the invention relates to a cellulose ester “dope” comprising a cellulose ester substituted with a C2-C7 acyl radical and having a degree of substitution of hydroxyl groups of about 1.01 to about 1.55 and a Δn⁶³³<0, and optionally comprising one or more plasticizers, and an organic solvent or blend of more than one organic solvent, wherein the cellulose ester comprises about 1 to about 50 wt % of the composition of the “dope,” and the plasticizer comprises about 0 to about 30 wt % of the composition of the “dope,” and the organic solvent or blend of organic solvents comprises from about 20 to about 99% of the composition of the “dope”.

In another embodiment, the invention relates to a cellulose acetate “dope” comprising a cellulose acetate having a degree of substitution of hydroxyl groups of about 0.5 to about 2.00 and a Δn⁶³³<0, and optionally comprising one or more plasticizers, and an organic solvent or blend of more than one organic solvent.

In another embodiment, the invention relates to a cellulose acetate “dope” comprising a cellulose acetate having a degree of substitution of hydroxyl groups of about 0.5 to about 2.00 and a Δn⁶³³<0, and optionally comprising one or more plasticizers, and an organic solvent or blend of more than one organic solvent, wherein the cellulose acetate comprises about 1 to about 50 wt % of the composition of the “dope,” and the plasticizer comprises about 0 to about 30 wt % of the composition of the “dope,” and the organic solvent or blend of organic solvents comprises from about 20 to about 99% of the composition of the “dope”.

In another embodiment, the invention relates to a cellulose acetate “dope” comprising a cellulose acetate having a degree of substitution of hydroxyl groups of about 0.75 to about 1.75 and a Δn⁶³³<0, and optionally comprising one or more plasticizers, and an organic solvent or blend of more than one organic solvent, wherein the cellulose acetate comprises about 1 to about 50 wt % of the composition of the “dope,” and the plasticizer comprises about 0 to about 30 wt % of the composition of the “dope,” and the organic solvent or blend of organic solvents comprises from about 20 to about 99% of the composition of the “dope”.

In another embodiment, the invention relates to a cellulose acetate “dope” comprising a cellulose acetate having a degree of substitution of hydroxyl groups of about 1.01 to about 1.55 and a Δn⁶³³<0, and optionally comprising one or more plasticizers, and an organic solvent or blend of more than one organic solvent, wherein the cellulose acetate comprises about 1 to about 50 wt % of the composition of the “dope,” and the plasticizer comprises about 0 to about 30 wt % of the composition of the “dope,” and the organic solvent or blend of organic solvents comprises from about 20 to about 99% of the composition of the “dope”.

In another embodiment, the invention relates to a cellulose acetate propionate “dope” comprising a cellulose acetate propionate having a degree of substitution of hydroxyl groups of about 0.5 to about 2.00 and a Δn⁶³³<0, and optionally comprising one or more plasticizers, and an organic solvent or blend of more than one organic solvent.

In another embodiment, the invention relates to a cellulose acetate propionate “dope” comprising a cellulose acetate propionate having a degree of substitution of hydroxyl groups of about 0.5 to about 2.00 and Δn⁶³³<0, and optionally comprising one or more plasticizers, and an organic solvent or blend of more than one organic solvent, wherein the cellulose acetate propionate comprises about 1 to about 50 wt % of the composition of the “dope,” and the plasticizer comprises about 0 to about 30 wt % of the composition of the “dope,” and the organic solvent or blend of organic solvents comprises from about 20 to about 99% of the composition of the “dope”.

In another embodiment, the invention relates to a cellulose acetate propionate “dope” comprising a cellulose acetate propionate having a degree of substitution of hydroxyl groups of about 0.75 to about 1.75 and a Δn⁶³³<0, and optionally comprising one or more plasticizers, and an organic solvent or blend of more than one organic solvent, wherein the cellulose acetate propionate comprises about 1 to about 50 wt % of the composition of the “dope,” and the plasticizer comprises about 0 to about 30 wt % of the composition of the “dope,” and the organic solvent or blend of organic solvents comprises from about 20 to about 99% of the composition of the “dope”.

In another embodiment, the invention relates to a cellulose acetate propionate “dope” comprising a cellulose acetate propionate having a degree of substitution of hydroxyl groups of about 1.01 to about 1.55 and a Δn⁶³³<0, and optionally comprising one or more plasticizers, and an organic solvent or blend of more than one organic solvent, wherein the cellulose acetate propionate comprises about 1 to about 50 wt % of the composition of the “dope,” and the plasticizer comprises about 0 to about 30 wt % of the composition of the “dope,” and the organic solvent or blend of organic solvents comprises from about 20 to about 99% of the composition of the “dope”.

In another embodiment, the invention relates to a cellulose acetate butyrate “dope” comprising a cellulose acetate butyrate having a degree of substitution of hydroxyl groups of about 0.5 to about 2.00 and a Δn⁶³³<0, and optionally comprising one or more plasticizers, and an organic solvent or blend of more than one organic solvent.

In another embodiment, the invention relates to a cellulose acetate butyrate “dope” comprising a cellulose acetate butyrate having a degree of substitution of hydroxyl groups of about 0.5 to about 2.00 and a Δn⁶³³<0, and optionally comprising one or more plasticizers, and an organic solvent or blend of more than one organic solvent, wherein the cellulose acetate butyrate comprises about 1 to about 50 wt % of the composition of the “dope,” and the plasticizer comprises about 0 to about 30 wt % of the composition of the “dope,” and the organic solvent or blend of organic solvents comprises from about 20 to about 99% of the composition of the “dope”.

In another embodiment, the invention relates to a cellulose acetate butyrate “dope” comprising a cellulose acetate butyrate having a degree of substitution of hydroxyl groups of about 0.75 to about 1.75 and a Δn⁶³³<0, and optionally comprising one or more plasticizers, and an organic solvent or blend of more than one organic solvent, wherein the cellulose acetate butyrate comprises about 1 to about 50 wt % of the composition of the “dope,” and the plasticizer comprises about 0 to about 30 wt % of the composition of the “dope,” and the organic solvent or blend of organic solvents comprises from about 20 to about 99% of the composition of the “dope”.

In another embodiment, the invention relates to a cellulose acetate butyrate “dope” comprising a cellulose acetate butyrate having a degree of substitution of hydroxyl groups of about 1.01 to about 1.55 and a Δn⁶³³<0, and optionally comprising one or more plasticizers, and an organic solvent or blend of more than one organic solvent, wherein the cellulose acetate butyrate comprises about 1 to about 50 wt % of the composition of the “dope,” and the plasticizer comprises about 0 to about 30 wt % of the composition of the “dope,” and the organic solvent or blend of organic solvents comprises from about 20 to about 99% of the composition of the “dope”.

Organic solvents which are useful for preparation of the “dope” according to the present invention may be employed without any limitations as long as they are capable of simultaneously dissolving the cellulose ester and any additional additives, such as plasticizers. In certain embodiments of the present invention, the organic solvents comprise halogenated solvents and/or non-halogenated solvents. Examples of halogenated solvents include, but are not limited to, methylene chloride, chloroform, dichloroethane, 2,2,2-trifluoroethanol, 2,2,3,3-hexafluoro-1-propanol, 1,3-difluoro-2-propanol, 1,1,1,3,3,3-hexafluoro-2-methyl-2-propanol, 1,1,1,3,3,3-hexafluoro-2-propanol, 2,2,3,3,3-pentafluoro-1-propanol. Examples of non-halogenated solvents include, but are not limited to, methyl acetate, ethyl acetate, n-propyl acetate, isopropyl acetate, n-butyl acetate, isobutyl acetate, sec-butyl acetate, tert-butyl acetate, amyl acetate, acetone, tetrahydrofuran, toluene, 1,3-dioxolane, 1,4-dioxane, cyclohexanone, ethyl formate, and nitroethane.

In certain embodiments according to the present invention, in addition to the solvent used to make the dope, typically halogenated or non-halogenated organic solvents, alcohols having 1 to 4 carbon atoms are incorporated into a dope in an amount of 0.1 to 40 percent by weight. In certain embodiments according to the present invention, increased alcohol ratio in the dope results in easier removal of the cast film from a metal support. When the alcohol ratio is low (i.e., ranges from about 0.1 wt % to about 15 wt %, based on the weight of cellulose ester, organic solvent, plasticizer, and alcohol), dissolution of cellulose ester in a non-halogenated organic solvent system is promoted. Examples of alcohols having 1 to 4 carbon atoms include methanol, ethanol, n-propanol, isopropanol, n-butanol, sec-butanol, and tert-butanol.

In certain embodiments according to the present invention, the high DS_{OH} cellulose ester films described above can be used in combination with an optically anisotropic compound, for example, those disclosed in U.S. Pat. No. 6,569,502.

The high DS_{OH} cellulose ester films described above can be used alone or in combination with an additional optical compensation film or films, such as a multi-layer or single layer film containing one or more optically anisotropic compounds, and/or discotic or rod-like liquid crystalline compounds.

The high DS_{OH} cellulose ester films described above may contain one or more additives, including, but not limited to, plasticizers and/or UV inhibitors, and can be used in combination with a film containing an optically anisotropic compound including, but not limited to those disclosed in U.S. Pat. No. 6,569,502.

Plasticizers, matting agents, UV absorbers, antioxidants, dyes, and the like may also be incorporated into the dope.

Cellulose esters, having an acetyl group as well as a propionyl or butyryl group employed in the present invention, do not require a plasticizer, although plasticizers are often used. As a result, sufficient film properties are often obtained without the addition of plasticizer, or at most addition in small amounts. However, in some embodiments according to the present invention, plasticizers may be added for other purposes. For example, for the purpose of enhancing the moisture resistance of film, alkyl phthalyl alkyl glycolates, phosphoric acid esters, carboxylic acid esters, phthalic acid ester, fatty acid ester, citric acid ester and the like may be used.

Examples of alkyl phthalyl alkyl glycolates are, include, methyl phthalyl methyl glycolate, ethyl phthalyl ethyl glycolate, propyl phthalyl propyl glycolate, butyl phthalyl butyl glycolate, octyl phthalyl octyl glycolate, methyl phthalyl ethyl glycolate, ethyl phthalyl methyl glycolate, methyl phthalyl propyl glycolate, methyl phthalyl butyl glycolate, ethyl phthalyl butyl glycolate, butyl phthalyl methyl glycolate, butyl phthalyl ethyl glycolate, propyl phthalyl butyl glycolate, butyl phthalyl propyl glycolate, methyl phthalyl octyl glycolate, ethyl phthalyl octyl glycolate, octyl phthalyl methyl glycolate, octyl phthalyl ethyl glycolate, and the like.

Examples of phosphoric acid esters include triphenyl phosphate, tricresyl phosphate, cresyl diphenyl phosphate, phenyl diphenyl phosphate, octyl diphenyl phosphate, trioctyl phosphate, tributyl phosphate, and the like.

Carboxylic acid esters include, for example, phthalic acid esters and citric acid esters. Examples of phthalic acid esters include dimethyl phthalate, diethyl phthalate, dimethoxyethyl phthalate, dimethyl phthalate, dioctyl phthalate, dibutyl phthalate, di-2-ethyl hexyl phthalate, and the like. Examples of citric acid esters include acetyl trimethyl citrate, acetyl triethyl citrate, and acetyl tributyl acetate.

In addition, butyl oleate, methyl acetyl recinoleate, dibutyl sebacate, triacetin, and the like are employed individually or in combination.

If desired, two or more types of plasticizers may be employed in combination. Phosphoric acid ester based plasticizers are preferred, in some embodiments of the present invention, because when employed at a ratio of no more than 50 weight percent, based on the total weight of the dope, the cellulose ester film is not hydrolyzed or degraded by the phosphoric acid ester based plasticizers. Further, a low content of phosphoric acid based plasticizers is preferred. Particularly preferred is the sole use of phthalic acid ester based or glycolic acid ester based plasticizers of these, methyl phthalyl methyl glycolate, ethyl phthalyl ethyl glycolate, propyl phthalyl propyl glycolate, butyl phthalyl butyl glycolate, and octyl phthalyl octyl glycolate are preferred, and more particularly preferred are ethyl phthalyl ethyl glycolate. Alternatively, two or more types of these alkyl phthalyl alkyl glycolates are employed in combination. The amount of plasticizers employed is typically between 1 and 30 percent with respect to the cellulose ester, or between 4 and 13 percent. These compounds may be added along with the cellulose ester and solvents during preparation of a cellulose ester solution or may be added during the preparation of the solution or after said preparation.

In some embodiments of the present invention, dyes are typically added to improve yellow hue of film. Since cellulose ester film is often tinted slightly yellow, dyes are preferred which are capable of tinting to gray as seen in common photographic supports. Thus blue and violet dyes are preferably employed. However, being different from the photographic supports, since it is unnecessary to minimize light piping, only a small amount of dye addition may be needed. Specifically the content of dyes is preferably between 1 and 100 ppm with respect to the cellulose ester, and is more preferably between 2 and 50 ppm. Gray may be obtained by appropriately combining a plurality of dyes.

When films are subject to blocking with each other the ease of handling is impaired. In some embodiments of the present invention, matting agents such as fine inorganic particles including silicon dioxide, titanium dioxide, sintered calcium silicate, hydrated calcium silicate, aluminum silicate, magnesium silicate, crosslinked polymers, and the like are typically incorporated into certain films to reduce blocking.

Further, in order to decrease the haze of a film, fine particles such as silicon dioxide are preferably subjected to surface treatment employing organic substances. Examples of organic substances for surface treatment include halosilanes, alkoxysilanes, silazanes, siloxanes, and the like. The matting effect increases as the average particle diameter of fine particles increases, while transparency increases as said diameter decreases. Typically, the average primary particles diameter of fine particles is no more than 0.1 microns, preferably between 5 and 50 nm, and more preferably between 7 and 14 nm. Examples of fine particles of silicon dioxide are Aerosil 200, 200V, 300, R972, R972V, R974, R202, R812, OX50, TT600 and the like, all of which are manufactured by Nihon Aerosil Co., ltd. Of these, preferred examples are Aerosil R972, R972V, R974, R202, R812, and the like. The matting agents are typically blended to obtain a film haze of no more than 0.6 percent, and a friction coefficient of no more than 0.5. The amount of matting agents employed is typically between 0.005 and 0.3 percent with respect to the cellulose ester. These fine particles usually exist in an aggregated form in the film and typically the surface of the film roughness ranges from 0.01 to 1.0 microns.

Liquid crystal displays are increasingly employed in the open atmosphere. Thus it is important to provide a protective film for a polarizing plate to absorb ultraviolet rays. UV absorbers are may be incorporated into the film of the present invention. Typical UV absorbers are those which efficiently absorb ultraviolet rays having a wavelength of no longer than 370 nm, which reduce the degradation of liquid crystals and which minimally absorb visible light having a wavelength of at least 400 nm. Typically, the transmittance at a wavelength of 370 nm is no more than 10 percent. The added amount of UV absorbers is typically in the range of 0.5 to 5 weight percent with respect to the cellulose ester, or in the range of 0.6 to 2.0 weight percent or 0.8 to 2.0 wt %. UV absorbers preferably have no absorption in the visible light range. Examples of such UV absorbers are benzotriazole based compounds, benzophenone based compounds, salicylic acid based compounds and the like. Examples of such UV absorbers include 2-(2′-hydroxy-5-methylphenyl)benzotriazole, 2-(2′-hydroxy-3′,5′-di-t-butylphenyl)benzotriazole, 2-(2′-hydroxy-3′-di-t-butyl-methylphenyl)benzotriazole, 2,4-dihydroxybenzophenone, 2-hydroxy-4-methoxybenzophenone, 2-hydroxy-4-n-octocybenzophenone, 4-dodecyloxy-2-hydrooxybenzophenone, 2,2′,4,4′-tetrahydroxybenzophenone, 2,2′-dihydroxoy-4,4′-dimethoxybenzophenone, phenyl salicylate, methyl salicylate, and the like.

In some embodiments of the present invention, at least one of these UV absorbers is typically employed, and at least two of different UV absorbers may be incorporated.

The addition methods of said UV absorbers include the following methods. The UV absorbers may be dissolved in organic solvents such as alcohol, methylene chloride, dioxolane, and the like and the resulting solution is added to a dope. Alternatively, the UV absorbers may be added directly to a dope. UV absorbers such as inorganic powders, which are not soluble in organic solvents, may be dispersed into a mixture of organic solvents and cellulose ester, employing a dissolver or a sand mill, and added to a dope.

In the present invention, the employed amount of UV absorbers is commonly between 0.1 and 2.5 weight percent with respect to the cellulose ester or between 0.5 and 2.0 weight percent or between 0.8 and 2.0 percent. UV absorbers used in excess of 2.5 percent often degrades the transparency of the cellulose ester.

In order to enhance the heat resistance of a film, hindered phenol based compounds are often employed. The added amount of these compounds is between 1 ppm and 1.0 percent by weight with respect to the cellulose ester or 10 and 1,000 ppm. Further, in addition to these compounds, heat stabilizers such as alkali earth metal salts comprised of calcium, magnesium, and the like, may also be added.

In addition to the aforementioned compounds, further, added may be antistatic agents, flame retarders, lubricants, oils, and the like.

The high DS_{OH} cellulose ester films described above may be applied to an optical film or plate as a coating.

The high DS_{OH} cellulose ester films described above may be generated by melt extrusion.

In another embodiment, the invention relates to a liquid crystal display comprising a single layer film comprising a cellulose ester substituted with a C2-C7 acyl radical and having a degree of substitution of hydroxyl groups of about 0.5 to about 2.00 and a Δn⁶³³<0, and optionally comprising one or more plasticizers.

In another embodiment, the invention relates to a liquid crystal display comprising a single layer film comprising a cellulose ester substituted with a C2-C7 acyl radical and having a degree of substitution of hydroxyl groups of about 0.75 to about 1.75 and a Δn⁶³³<0, and optionally comprising one or more plasticizers.

In another embodiment, the invention relates to a liquid crystal display comprising a single layer film comprising a cellulose ester substituted with a C2-C7 acyl radical and having a degree of substitution of hydroxyl groups of about 1.01 to about 1.55 and a Δn⁶³³<0, and optionally comprising one or more plasticizers.

In another embodiment, the invention relates to a liquid crystal display comprising a single layer film comprising a mixed cellulose ester substituted with more than one C2-C7 acyl radical and having a degree of substitution of hydroxyl groups of about 0.5 to about 2.00 and a Δn⁶³³<0, and optionally comprising one or more plasticizers.

In another embodiment, the invention relates to a liquid crystal display comprising a single layer film comprising a mixed cellulose ester substituted with more than one C2-C7 acyl radical and having a degree of substitution of hydroxyl groups of about 0.75 to about 1.75 and a Δn⁶³³<0, and optionally comprising one or more plasticizers.

In another embodiment, the invention relates to a liquid crystal display comprising a single layer film comprising a mixed cellulose ester substituted with more than one C2-C7 acyl radical and having a degree of substitution of hydroxyl groups of about 1.01 to about 1.55 and a Δn⁶³³<0, and optionally comprising one or more plasticizers.

In another embodiment, the invention relates to a single layer film comprising a cellulose ester substituted with a C2-C7 acyl radical and having a degree of substitution of hydroxyl groups of about 0.5 to about 2.00 and a Δn⁶³³<0, and optionally comprising one or more plasticizers, wherein the film is uniaxially or biaxially stretched.

In another embodiment, the invention relates to a single layer film comprising a cellulose ester substituted with a C2-C7 acyl radical and having a degree of substitution of hydroxyl groups of about 0.75 to about 1.75 and a Δn⁶³³<0, and optionally comprising one or more plasticizers, wherein the film is uniaxially or biaxially stretched.

In another embodiment, the invention relates to a single layer film comprising a cellulose ester substituted with a C2-C7 acyl radical and having a degree of substitution of hydroxyl groups of about 1.01 to about 1.55 and a Δn⁶³³<0, and optionally comprising one or more plasticizers, wherein the film is uniaxially or biaxially stretched.

In another embodiment, the invention relates to a single layer film comprising a mixed cellulose ester substituted with more than one C2-C7 acyl radical and having a degree of substitution of hydroxyl groups of about 0.5 to about 2.00 and a Δn⁶³³<0, and optionally comprising one or more plasticizers, wherein the film is uniaxially or biaxially stretched.

In another embodiment, the invention relates to a single layer film comprising a mixed cellulose ester substituted with more than one C2-C7 acyl radical and having a degree of substitution of hydroxyl groups of about 0.75 to about 1.75 and a Δn⁶³³<0, and optionally comprising one or more plasticizers, wherein the film is uniaxially or biaxially stretched.

In another embodiment, the invention relates to a single layer film comprising a mixed cellulose ester substituted with more than one C2-C7 acyl radical and having a degree of substitution of hydroxyl groups of about 1.01 to about 1.55 and a Δn⁶³³<0, and optionally comprising one or more plasticizers, wherein the film is uniaxially or biaxially stretched.

In another embodiment, the invention relates to a liquid crystal display comprising a single layer compensation film comprising a cellulose ester substituted with a C2-C7 acyl radical and having a degree of substitution of hydroxyl groups of about 0.5 to about 2.00 and a Δn⁶³³<0, and optionally comprising one or more plasticizers.

In another embodiment, the invention relates to a liquid crystal display comprising a single layer compensation film comprising a cellulose ester substituted with a C2-C7 acyl radical and having a degree of substitution of hydroxyl groups of about 0.75 to about 1.75 and a Δn⁶³³<0, and optionally comprising one or more plasticizers.

In another embodiment, the invention relates to a liquid crystal display comprising a single layer compensation film comprising a cellulose ester substituted with a C2-C7 acyl radical and having a degree of substitution of hydroxyl groups of about 1.01 to about 1.55 and a Δn⁶³³<0, and optionally comprising one or more plasticizers.

In another embodiment, the invention relates to a liquid crystaly display comprising a single layer compensation film comprising a mixed cellulose ester substituted with more than one C2-C7 acyl radical and having a degree of substitution of hydroxyl groups of about 0.5 to about 2.00 and a Δn⁶³³<0, and optionally comprising one or more plasticizers.

In another embodiment, the invention relates to a liquid crystal display comprising a single layer compensation film comprising a mixed cellulose ester substituted with more than one C2-C7 acyl radical and having a degree of substitution of hydroxyl groups of about 0.75 to about 1.75 and a Δn⁶³³<0, and optionally comprising one or more plasticizers.

In another embodiment, the invention relates to a liquid crystal display comprising a single layer compensation film comprising a mixed cellulose ester substituted with more than one C2-C7 acyl radical and having a degree of substitution of hydroxyl groups of about 1.01 to about 1.55 and a Δn⁶³³<0, and optionally comprising one or more plasticizers.

In another embodiment, the invention relates to a liquid crystal display comprising a single layer compensation film comprising a cellulose ester substituted with a C2-C7 acyl radical and having a degree of substitution of hydroxyl groups of about 0.5 to about 2.00 and a Δn⁶³³<0, and optionally comprising one or more plasticizers, wherein the film is unstretched or uniaxially stretched.

In another embodiment, the invention relates to a liquid crystal display comprising a comprising a single layer compensation film comprising a cellulose ester substituted with a C2-C7 acyl radical and having a degree of substitution of hydroxyl groups of about 0.75 to about 1.75 and a Δn⁶³³<0, and optionally comprising one or more plasticizers, wherein the film is unstretched or uniaxially stretched.

In another embodiment, the invention relates to a liquid crystal display comprising a single layer compensation film comprising a cellulose ester substituted with a C2-C7 acyl radical and having a degree of substitution of hydroxyl groups of about 1.01 to about 1.55 and a Δn⁶³³<0, and optionally comprising one or more plasticizers, wherein the film is unstretched or uniaxially stretched.

In another embodiment, the invention relates to a liquid crystal display comprising a single layer compensation film comprising a mixed cellulose ester substituted with more than one C2-C7 acyl radical and having a degree of substitution of hydroxyl groups of about 0.5 to about 2.00 and a Δn⁶³³<0, and optionally comprising one or more plasticizers, wherein the film is unstretched or uniaxially stretched.

In another embodiment, the invention relates to a liquid crystal display comprising a single layer compensation film comprising a mixed cellulose ester substituted with more than one C2-C7 acyl radical and having a degree of substitution of hydroxyl groups of about 0.75 to about 1.75 and a Δn⁶³³<0, and optionally comprising one or more plasticizers, wherein the film is unstretched or uniaxially stretched.

In another embodiment, the invention relates to a liquid crystal display comprising a single layer compensation film comprising a mixed cellulose ester substituted with more than one C2-C7 acyl radical and having a degree of substitution of hydroxyl groups of about 1.01 to about 1.55 and a Δn⁶³³<0, and optionally comprising one or more plasticizers, wherein the film is unstretched or uniaxially stretched.

In another embodiment, the invention relates to a substrate in a liquid crystal display comprising a single layer film comprising a cellulose ester substituted with a C2-C7 acyl radical and having a degree of substitution of hydroxyl groups of about 0.5 to about 2.00 and a Δn⁶³³<0, and optionally comprising one or more plasticizers.

In another embodiment, the invention relates to a substrate in a liquid crystal display comprising a single layer film comprising a cellulose ester substituted with a C2-C7 acyl radical and having a degree of substitution of hydroxyl groups of about 0.75 to about 1.75 and a Δn⁶³³<0, and optionally comprising one or more plasticizers.

In another embodiment, the invention relates to a substrate in a liquid crystal display comprising a single layer film comprising a cellulose ester substituted with a C2-C7 acyl radical and having a degree of substitution of hydroxyl groups of about 1.01 to about 1.55 and a Δn⁶³³<0, and optionally comprising one or more plasticizers.

In another embodiment, the invention relates to a substrate in a liquid crystal display comprising a single layer film comprising a mixed cellulose ester substituted with more than one C2-C7 acyl radical and having a degree of substitution of hydroxyl groups of about 0.5 to about 2.00 and a Δn⁶³³<0, and optionally comprising one or more plasticizers.

In another embodiment, the invention relates to a substrate in a liquid crystal display comprising a single layer film comprising a mixed cellulose ester substituted with more than one C2-C7 acyl radical and having a degree of substitution of hydroxyl groups of about 0.75 to about 1.75 and a Δn⁶³³<0, and optionally comprising one or more plasticizers.

In another embodiment, the invention relates to a substrate in a liquid crystal display comprising a single layer film comprising a mixed cellulose ester substituted with more than one C2-C7 acyl radical and having a degree of substitution of hydroxyl groups of about 1.01 to about 1.55 and a Δn⁶³³<0, and optionally comprising one or more plasticizers.

In another embodiment, the invention relates to a liquid crystal display comprising a multifunctional single layer substrate and compensation film comprising a cellulose ester substituted with a C2-C7 acyl radical and having a degree of substitution of hydroxyl groups of about 0.5 to about 2.00 and a Δn⁶³³<0, and optionally comprising one or more plasticizers.

In another embodiment, the invention relates to a liquid crystal display comprising a multifunctional single layer substrate and compensation film comprising a cellulose ester substituted with a C2-C7 acyl radical and having a degree of substitution of hydroxyl groups of about 0.75 to about 1.75 and a Δn⁶³³<0, and optionally comprising one or more plasticizer.

In another embodiment, the invention relates to a liquid crystal display comprising a multifunctional single layer substrate and compensation film comprising a cellulose ester substituted with a C2-C7 acyl radical and having a degree of substitution of hydroxyl groups of about 1.01 to about 1.55 and a Δn⁶³³<0, and optionally comprising one or more plasticizers.

In another embodiment, the invention relates to a liquid crystal display comprising a multifunctional single layer substrate and compensation film comprising a mixed cellulose ester substituted with more than one C2-C7 acyl radical and having a degree of substitution of hydroxyl groups of about 0.5 to about 2.00 and a Δn⁶³³<0, and optionally comprising one or more plasticizers.

In another embodiment, the invention relates to a liquid crystal display comprising a multifunctional single layer substrate and compensation film comprising a mixed cellulose ester substituted with more than one C2-C7 acyl radical and having a degree of substitution of hydroxyl groups of about 0.75 to about 1.75 and a Δn⁶³³<0, and optionally comprising one or more plasticizers.

In another embodiment, the invention relates to a liquid crystal display comprising a multifunctional single layer substrate and compensation film comprising a mixed cellulose ester substituted with more than one C2-C7 acyl radical and having a degree of substitution of hydroxyl groups of about 1.01 to about 1.55 and a Δn⁶³³<0, and optionally comprising one or more plasticizers.

The cellulose esters described in this invention can be prepared by a number of synthetic routes, including, but not limited to, acid-catalyzed hydrolysis of a previously prepared cellulose ester in an appropriate solvent or mixture of solvents and base-catalyzed hydrolysis of a previously prepared cellulose ester in an appropriate solvent or mixture of solvents. Additionally, high DS_{OH} cellulose esters can be prepared from cellulose by a number of known methods. For additional details on synthetic routes for preparing high DS_{OH} cellulose esters, see U.S. Pat. No. 2,327,770; Gedon, S, and Fengl, R., “Cellulose Esters, Organic Esters,” from Kirk-Othmer Encyclopedia of Chemical Technology,” Fifth Edition, vol. 5, pp 412-444, 2004, John Wiley & Sons, Hoboken, N.J.; Klemm, D., et. al. “Comprehensive Cellulose Chemistry: Volume 2 Functionalization of Cellulose,” Wiley-VCH, New York, 1998).

In one embodiment, conventional cellulose esters (for example, but not limited to CAB-381-20 and CAP-482-20, commercially available from Eastman Chemical Company) are dissolved in an organic carboxylic acid, such as acetic acid, propionic acid, or butyric acid, or mixture of organic carboxylic acids, such as acetic acid, propionic acid, or butyric acid to form a dope. The resulting cellulose ester dopes can be treated with water and an inorganic acid catalyst, including, but not limited to, sulfuric acid, hydrochloric acid, and phosphoric acid. Those skilled in the art will also recognize that the reaction time, temperature, catalyst type, catalyst loading, and possibly solid level will impact the DS_{OH} in the final cellulose ester and that these factors can also affect the degree of polymerization of the cellulose backbone in the final cellulose ester. These changes will impact many physical properties such as Tg, IV, molecular weight and can impact the polymers performance by producing changes in, for example, the solubility of the ester, and the water permeability of the ester and films of the ester.

The same hydrolysis protocols described above can be accomplished with non-acidic catalysts, such as bases. Additionally, solid catalysts such as ion exchange resins can be used. Additionally, the solvent used to dissolve the initial cellulose ester prior to hydrolysis can be an organic solvent that is not an organic acid solvent, examples of which include, but are not limited to, ketones, alcohols, dimethyl sulfoxide (DMSO), and N,N-dimethylformamide (DMF).

Additional methods for preparing high DS_{OH} cellulose esters include preparation of the high DS_{OH} cellulose esters from cellulose from wood or cotton. The cellulose can be a high purity dissolving grade wood pulp or cotton linters. The cellulose could alternately be isolated from any of a number of biomass sources including, but not limited to, corn fiber.

Those skilled in the art recognize that there are a number of possible processes known for preparing optical quality films applicable to the high DS_{OH} cellulose esters films described above. A common method used for preparing a high DS_{OH} cellulose ester film on a commercial scale is a solvent casting process in which the high DS_{OH} cellulose ester is dissolved in a solvent and cast onto a belt or roll and the solvent is removed to produce a film. There are many variations of this process and many, if not all, are applicable to generating high DS_{OH} cellulose ester films of this invention.

One example of solvent casting for cellulose acetate film is disclosed in U.S. Pat. No. 7,084,944. The cellulose acetate film is preferably prepared according to a solvent casting method. As the solvent, an organic solvent is preferably used. The solvent cast method comprises the steps of dissolving cellulose acetate in an organic solvent to prepare a solution (dope) and casting the dope to prepare a film.

In certain embodiments, the organic solvent is preferably selected from the group consisting of an ether having 3 to 12 carbon atoms, a ketone having 3 to 12 carbon atoms, an ester having 3 to 12 carbon atoms, a halogenated hydrocarbon having 1 to 6 carbon atoms and mixtures thereof.

The ether, ketone and ester may have a cyclic structure. A compound having two or more functional groups of ether (—O—), ketone (—CO—) and ester (—COO—) can be also used as the organic solvent. The organic solvent can have another functional group such as alcoholic hydroxyl.

Examples of the ether having 3 to 12 carbon atoms include, but are not limited to, diisopropyl ether, dimethoxymethane, 1,4-dioxane, 1,3-dioxolane, tetrahydrofuran, anisole and phenetol.

Examples of the ketone having 3 to 12 carbon atom include, but are not limited to, acetone, methyl ethyl ketone, diethyl ketone, diisobutyl ketone, cyclohexanone and methylcyclohexanone.

Examples of the ester having 3 to 12 carbon atoms include, but are not limited to, ethyl formate, propyl formate, pentyl formate, methyl acetate, ethyl acetate, and pentyl acetate.

Examples of the compounds having two or more kinds of functional groups include, but are not limited to, 2-ethoxyethyl acetate, 2-methoxyethanol and 2-butoxyethanol.

The halogenated hydrocarbon has preferably one or two carbon atoms, more preferably one carbon atom. The halogen atom of the halogenated hydrocarbon is preferably chlorine. In certain embodiments of the present invention, the ratio of hydrogen substituted with halogen is preferably in the range of 25 to 75 mol %, more preferably in the range of 30 to 70 mol %, further preferably in the range of 35 to 65 mol %, and most preferably in the range of 40 to 60 mol %. Methylene chloride is a representative halogenated hydrocarbon.

In some embodiments of the present invention, two or more organic solvents can be used in combination.

A cellulose acetate solution can be prepared according to a conventional method. The conventional method means that the solution is prepared at a temperature of not lower than 0° C. (room temperature or elevated temperature). The preparation of the solution can be conducted by means of a process and apparatus used in a conventional solvent cast method. The conventional method typically uses a halogenated hydrocarbon (particularly methylene chloride) as an organic solvent.

In certain embodiments, the amount of cellulose acetate in a solution typically ranges from about 10 to 40 wt. % based on the weight of the cellulose ester and the solvent. In some embodiments, the amount of cellulose acetate is more preferably 10 to 30 wt. %. An optional additive (described below) can be added to an organic solvent.

The solution can be prepared by stirring cellulose acetate and an organic solvent at a temperature ranging from about 0 to 40° C. Solutions having higher concentrations of cellulose ester may be prepared by stirring them at an elevated temperature under a high pressure. Typically the cellulose acetate and the organic solvent are placed in a closed vessel, and are stirred at an elevated temperature under a high pressure. The reactor temperature is generally above the atmospheric boiling point but lower than the boiling point of the solvent at the increased reactor pressure. Accordingly, the reactor temperature is normally not lower than 40° C., preferably in the range of 60 to 200° C., and more preferably in the range of 80 to 110° C.

The components can be preliminary dispersed coarsely, and the coarse dispersion can be placed in the vessel. Otherwise, the components can be also introduced into the vessel in sequentially and optionally in portions. The vessel is typically equipped with a stirring device. The vessel can be pressurize using an inert gas such as nitrogen gas, or by heating and evaporating the solvent to increase the vapor pressure.

The vessel is typically heated from the outside, for example, with a jacket type heating apparatus, or with liquid heated with a plate heater placed outside of the vessel may be circulated through a pipe wound around the vessel, to heat the whole vessel. Other conventional heating methods, including heating through internal piping, may be used.

The mixture is preferably stirred with a propeller mixer provided in the vessel. The wing of the propeller preferably has a length reaching the inside wall of the vessel. Further, at the tip of the wing, a scratching mean is provided to scratch and renew the mixture attached on the inside wall.

In some embodiments, the components are dissolved in the solvent in the vessel to form the dope. The dope may be cooled and then taken out of the vessel, or may be taken out and then cooled with a heat exchanger.

The cellulose acetate solution can be also prepared according to a cooling dissolution method. Using this method, cellulose acetate can be dissolved in organic solvents in which cellulose acetate typically cannot be dissolved using a conventional method. This method may also be used to rapidly and homogeneously dissolved cellulose acetate in an organic solvent in which cellulose acetate can be dissolved by a conventional process.

In the cooling dissolution method, the cellulose acetate or cellulose ester is gradually added, with stirring, into an organic solvent at room temperature.

In some embodiments, the amount of the cellulose acetate in the mixture ranges about 10 to about 40 wt. %, or from about 10 to about 30 wt. %. Various additives described below may be added in the mixture.

At the next stage, the prepared mixture is cooled to a temperature of −100 to −10° C., or −80 to −10° C., or −50 to −20° C., or −50 to −30° C. The cooling procedure can be carried out, for example, with dry ice-methanol bath (−75° C.) or with cooled ethylene glycol solution (−30 to −20° C.). Through the cooling procedure, the mixture is solidified.

The cooling rate is 4° C./minute or more, or 8° C./minute or more, or 12° C./minute or 20° C./minute.

The cooled mixture is then warmed to a temperature of 0 to 200° C., or 0 to 150° C., or 0 to 120° C., or 0 to 50° C. The polymer dissolves into the organic solvent during the warming procedure.

The warming rate is 4° C./minute or more, or 8° C./minute or more, or 12° C./minute or more.

Thus, a homogeneous solution can be prepared. If the polymer is not sufficiently dissolved, the cooling and warming procedures may be repeated.

In the process of cooling dissolution method, a sealed vessel is preferably used to prevent contamination of water, which may be caused by dew condensation.

In certain embodiments, the polymer film is formed from the prepared polymer solution (dope) using a solvent cast method.

The dope is cast on a drum or a band, and the solvent is evaporated to form a film. In certain embodiments, the solid content of the dope typically ranges from about 18 to 35%, based on the total weight of the solvent and the cellulose ester. The surface of the drum or band is preferably polished to be a mirror-like finish. Typical casting and drying steps of the solvent cast method are described in U.S. Pat. Nos. 2,336,310, 7,208,205, 2,492,977, 2,492,978, 2,607,704, 2,739,069, 2,739,070, British Patent Nos. 640,731, 736,892, Japanese Patent Publication Nos. 45 (1970)-4554, 49 (1974)-5614, Japanese Patent Provisional Publication Nos. 60 (1985)-176834, 60 (1985)-203430 and 62 (1987)-115035.

In certain embodiments, the surface temperature of the drum or band is 10° C. or below. In certain embodiments, after the dope is cast onto the drum or band, the dope is blown with air for 2 seconds or more to dry the film. The formed film is then removed from the drum, and blown with hot air whose temperature is successively changed from 100° C. to 160° C. in order to evaporate remaining solvent. This procedure is described in Japanese Patent Publication No. 5 (1993)-47855.

Two or more layers can be formed from the dope using a simultaneous casting (co-casting) method including, but not limited to, the solvent cast method. The dope is cast on a drum or a band, and the solvent is evaporated to form a film. In some embodiments, the solid content of the dope ranges from about 10 to 40%, based on the total weight of the solvent and cellulose ester.

In the case where two or more cellulose acetate solutions are used, the solutions may be cast from nozzles provided at intervals in the transferring direction of the support to form a layered film. This method is described in, for example, Japanese Patent Provisional Publication Nos. 61 (1986)-158414, 1 (1989)-122419 and 11 (1999)-198285. The solutions may be simultaneously cast from two nozzles to form a layered film. This method is described in, for example, Japanese Patent Publication No. 60 (1985)-27562, Japanese Patent Provisional Publication Nos. 61 (1986)-94724, 61 (1986)-947245, 61 (1986)-104813, 61 (1986)-158413 and 6 (1994)-134933.

Further, the method described in Japanese Patent Provisional Publication No. 56 (1981)-162617 can be also adopted. In that method, a highly viscous cellulose acetate solution is enclosed with a low viscous one, and then the thus-combined solutions are simultaneously extruded and cast.

Furthermore, the method described in, for example, Japanese Patent Publication No. 44 (1969)-20235 may be adapted. In the method, a film is first formed from a solution extruded out of one of two nozzles. After the formed film is peeled and placed on the support, another solution is extruded from the other nozzle to cast onto the film (on the surface having faced to the support) to form a layered film.

The cellulose acetate solutions may be the same or different from each other. If some functional layers are to be formed, each cellulose acetate solution corresponding to each function may be extruded from each nozzle. Further, the cellulose acetate solution of the invention may be cast simultaneously with other dopes for other functional layers (e.g., adhesive layer, dye layer, antistatic layer, antihalation layer, ultraviolet layer, polarizing layer).

In the case where a thick film having a single layer is formed by the conventional solvent cast method, it is useful to extrude a dope of high concentration and high viscosity. That dope is generally so unstable that solid particles are often deposited, and that the formed film often has poor evenness. If the viscous dope is extruded simultaneously from plural nozzles onto the support, a thick film having excellent evenness can be prepared. Further, since the thick dope is rapidly dried, the film can be rapidly produced.

In some embodiments, a plasticizer can be added to the cellulose acetate film to improve the mechanical strength. The plasticizer also functions to shorten the drying process time. Phosphoric esters and carboxylic esters are typically used as the plasticizer. Examples of the phosphoric esters include, but are not limited to, triphenyl phosphate (TPP) and tricresyl phosphate (TCP). Examples of the carboxylic esters include, but are not limited to, phthalic esters and citric esters. Examples of the phthalic esters include, but are not limited to, dimethyl phthalate (DMP), diethyl phthalate (DEP), dibutyl phthalate (DBP), dioctyl phthalate (DOP), diphenyl phthalate (DPP) and diethylhexyl phthalate (DEHP). Examples of the citric esters include, but are not limited to, triethyl o-acetylcitrate (OACTE) and tributyl o-acetylcitrate (OACTB). Examples of the other carboxylic esters include, but are not limited to, butyl oleate, methylacetyl ricinoleate, dibutyl sebacate and various trimellitic esters. In some embodiments, phthalic ester plasticizers (DMP, DEP, DBP, DOP, DPP, DEHP) are preferred. In other embodiments, DEP and DPP are particularly preferred.

The amount of the plasticizer ranges from about 0.1 to 25 wt. %, or about 1 to 20 wt. %, or about 3 to 15 wt. % based on the total weight of cellulose ester in the film or dope.

Deterioration inhibitors (e.g., anti-oxidizing agent, peroxide decomposer, radical inhibitor, metal inactivating agent, oxygen scavenger, amine) can be incorporated into the cellulose acetate film. Some deterioration inhibitors are described in Japanese Patent Provisional Publication Nos. 3 (1991)-199201, 5 (1993)-1907073, 5 (1993)-194789, 5 (1993)-271471 and 6 (1994)-107854. The deterioration inhibitor typically ranges from about 0.01 to 1 wt. %, or about 0.01 to 0.2 wt. % based on the amount of the prepared solution (dope). If the amount is less than 0.01 wt. %, the effect of the deterioration inhibitor is usually ineffective. If the amount is more than 1 wt. %, the inhibitor would bleed out onto the surface of the film. In certain embodiments, butyrated hydroxytoluene (BHT) and tribenzylamine (TBA) are particularly preferred deterioration inhibitors.

In certain embodiments of the present invention, the high DS_{OH} cellulose ester films are prepared by melt extrusion.

The high DS_{OH} cellulose ester films described above can be used in a number of optical film applications, including, but not limited to LCDS.

In another embodiment, the invention relates to the use of a high DS_{OH} cellulose ester/solvent mixture, in other words a high DS_{OH} cellulose ester dope, in the process of forming a film useful in optical film applications, including roles in LCDs as substrates, compensation films, and other individual roles. In another embodiment, the high DS_{OH} cellulose ester film can be used in multi-functional roles in an LCD, such as a compensator/substrate.

In another embodiment, the invention relates to a high DS_{OH} cellulose ester film used as a substrate, wherein the film requires less, or no post treatment, such as surface saponification, commonly used to enhance the adhesion of TAC film to PVA layers in many polarizer applications and other optical films in LCDs applications. One example of surface saponification is disclosed in U.S. Pat. No. 7,084,944 for cellulose acetate film. Other surface treatments may be used to enhance the adhesion of TAC film to PVA layers.

Examples of the surface treatment include saponification treatment, plasma treatment, flame treatment and ultraviolet (UV) treatment. The saponification treatment includes acid saponification treatment and alkali saponification treatment. The plasma treatment includes glow discharge treatment and corona discharge treatment. In some embodiments, an undercoating layer is provided as described in Japanese Patent Provisional Publication No. 7 (1995)-333433.

In certain embodiments in which the optical compensatory sheet is used as the transparent protective film of the polarizing plate, the cellulose acetate film is subjected to acid or alkali saponification treatment to improve adhesion to the polarizing membrane.

The alkaline saponification treatment typically comprises the steps of immersing the cellulose ester film in an alkaline solution, neutralizing the film with an acidic solution, washing the film with water and drying. Examples of the alkaline solution include, but are not limited to, aqueous solutions of potassium hydroxide and sodium hydroxide. In some embodiments, the normality of hydroxyl ion in the alkali solution ranges from about 0.1 to 3.0 N, or about 0.5 to 2.0 N. The alkaline solution is kept at a temperature ranging from about room temperature to 90° C., or 40 to 70° C.

In some embodiments, the alkali comprises an alkali metal hydroxide such as potassium hydroxide and sodium hydroxide. The alkaline solution typically has a pH value of 10 to 14. Typically only the film surface facing to the polarizing membrane is immersed, but both surfaces of the cellulose acetate film may be immersed. The immersion period ranges from about 1 to 300 seconds, or about 5 to 240 seconds. The temperature for the saponification reaction ranges from about 25 to 70° C., or 35 to 60° C. After immersion in the alkaline solution, the film is preferably washed with water.

In embodiments in which only one surface is subjected to the alkaline saponification treatment, it is preferably washed with water after the alkaline solution is applied. In this case, the solvent of the alkaline solution preferably does not swell the cellulose ester film, and hence is preferably an alcohol (e.g., isopropanol, butanol). Further, a mixture containing other solvents (such as propylene glycol and water) for improving coating characters and alkali solubility may be used as the solvent.

The corona discharge treatment comprises the steps of applying high voltage between a roll of dielectrics and an electrode connected to a high voltage generator, and placing or moving the cellulose acetate film in a corona discharge generated between the roll and the electrode. The frequency of the high voltage applied between the roll and the electrode is referred to as “discharge frequency”. The corona discharge treatment is easily carried out in air, but it may be done in the presence of gas other than air or with an air-contaminated gas. Examples of the gas include nitrogen, argon and oxygen.

The discharge frequency is normally in the range of 50 Hz to 5,000 kHz, or in the range of 5 to several hundreds kHz. If the discharge frequency is too low, the discharge is so unstable that the resultant film has many pinholes. If the discharge frequency is too high, the treatment is too expensive because an impedance matching apparatus must also be used.

One method of improving the wettability of a cellulose acetate film provides subjecting the film to a corona discharge treatment ranging from about 0.001 to 5 kVAminute/m², or about 0.01 to 1 kVAminute/m². The gap between the roll and the electrode ranges from about 0.5 to 2.5 mm, or about 1.0 to 2.0 mm. The glow discharge treatment comprises the steps of applying high voltage between a pair of (or more) electrodes under low-pressured gas atmosphere, and placing or moving the cellulose acetate film in glow discharge generated between the electrodes.

The gas pressure typically ranges from about 0.005 to 20 Torr, or 0.02 to 2 Torr. If the gas pressure is too low, the surface treatment is ineffective. If the gas pressure is too high, excess current flows cause sparks and damage the film. The discharge is created by applying the voltage between a pair of (or more) metal plates or rods in a vacuum tank. The voltage depends upon the gas and its pressure, but is normally in the range of 500 to 5,000 V to form a stable stationary glow discharge. The voltage used in the process to improve the adhesion typically ranges from about 2,000 to 4,000 V. The discharge frequency ranges from about 0 (direct current) to several thousands MHz, or ranges from about 50 Hz to 20 MHz. The cellulose acetate film is subjected to glow discharge treatment ranging from about 0.01 to 5 kVAminute/m², or about 0.15 to 1 kVAminute/m², to obtain desired adhesion strength.

In the ultraviolet (UV) treatment, the cellulose acetate film is exposed to ultraviolet rays. If the film surface may be heated to about 150° C. without harming the film, a high pressure mercury lamp (main wavelength: 365 nm) is a suitable light source. If the film must be treated at a low temperature, a low pressure mercury lamp (main wavelength: 254 nm) is suitable. Other suitable light sources include high and low pressure mercury lamps of ozone-less type. Adhesion is improved by increasing the UV light exposure of the film. Excessive UV light exposure causes the film to become colored and mechanically weakened. If a high pressure mercury lamp (main wavelength: 365 nm) is used, the exposure level of UV light ranges from about 20 to 10,000 mJ/cm², or about 50 to 2,000 mJ/cm². If a low pressure mercury lamp (main wavelength: 254 nm) is used, the exposure level of UV light ranges from about 100 to 10,000 mJ/cm², or about 300 to 1,500 mJ/cm².

A further embodiment relates to a multifunctional film comprising a cellulose C2-C7 ester with a DS_{OH} of about 0.4 to about 2.00, preferably 0.75 to about 1.75, more preferably about 1.01 to about 1.55, and a Δn⁶³³<0, preferably <−0.001, more preferably <−0.0025, prepared by dissolving the cellulose ester in a solvent to form a dope, the dope is cast onto a belt and the solvent is removed to form the film. The film may act as substrate, a protective layer, and/or a compensation sheet in liquid crystal displays.

Cellulose esters with high DS_{OH}s can be prepared by known methods, including hydrolysis with a mineral acid catalyst (including, but not limited to, hydrochloric acid, sulfuric acid, nitric acid, and phosphoric acid and mixtures thereof), hydrolysis/saponification with a basic catalyst (including, but not limited to, sodium hydroxide, sodium bicarbonate, and mixtures thereof), hydrolysis using a solid acid catalyst (including, but not limited to, a H⁺ cationic exchange resin), and hydrolysis using a Lewis acid catalyst (including, but not limited to, metal triflates such as silver triflate, scandium triflate, and others).

Those skilled in the art will recognize that selection of catalyst, catalyst level, water level, solvent, solvent level, time, and temperature may influence the rate of reaction and the product generated.

### EXPERIMENTAL

### Determination of Degree of Substitution by NMR

The proton nuclear magnetic resonance (¹H-NMR) results were obtained using a JEOL Model GX-400 NMR spectrometer operated at 400 MHz. Sample tube size was 5 mm. The sample temperature was 80° C., the pulse delay 5 seconds and 64 scans were acquired for each experiment. Chemical shifts are reported in ppm from tetramethylsilane, with residual DMSO as an internal reference. The chemical shift of residual DMSO is set to 2.49 ppm.

Unless otherwise noted:

DS_{Ac}=Degree of substitution of acetyl as determined by ¹H-NMR
DS_{Pr}=Degree of substitution of propionyl as determined by ¹H-NMR
DS_{Bu}=Degree of substitution of butyryl as determined by ¹H-NMR

Degree of substitution of a cellulose acetate, cellulose acetate propionate, and cellulose acetate butyrate was determined by analyzing the ¹H-NMR spectrum and comparing the peak area of the integrated alkyl ester protons with the peak area of the cellulose backbone protons. According to this method, acetyl can be distinguished from the higher esters such as butyryl or propionyl, but butyryl cannot be distinguished from propionyl. As a result, one must assume that all the higher esters peaks come from either butyryl or propionyl, depending upon the anhydride used. This is a reasonable assumption for cellulose acetate butyrates since the level of propionyl in CABs is near zero when butyric anhydride is a reactant. ¹H-NMR does not indicate the degree of substitution of hydroxyl groups. The accepted method for determining the degree of substitution of hydroxyl groups is by difference, that is, one assumes a theoretical maximum degree of substitution (DS_{Max}) and from that number subtracts the degree of substitution of acetyl, for a cellulose acetate, acetyl and propionyl for a cellulose acetate propionate, and acetyl and butyryl for a cellulose acetate butyrate. The result is the degree of substitution of hydroxyl groups, as shown in equations 4-6.

For a cellulose acetate:

DS_{Max}−DS_{Ac}=DS_{OH} Equation 4

For a cellulose acetate propionate:

DS_{Max}−DS_{Pr}−DS_{Ac}=DS_{OH} Equation 5

For a cellulose acetate butyrate:

DS_{Max}−DS_{Bu}−DS_{Ac}=DS_{OH} Equation 6

Ester substitutions for conventional molecular weight cellulose esters are calculated on the basis that the DS_{Max} is 3.0 due to the high degree of polymerization of conventional cellulose esters. As the degree of polymerization (i.e. molecular weight) of the cellulose ester decreases, the end group hydroxyls at C1 and C4 become more important and the maximum degree of substitution, DS_{Max} becomes >3.0. Low molecular weight cellulose esters having a DS_{Max} greater than 3.0 are included within the scope of the present invention. Cellulose esters having a DS_{Max} greater than 3.0, including up to about 3.67 are within the scope of the present invention. For most of the examples in this invention a DS_{Max} of 3.0 is assumed unless otherwise noted.

Traditionally, cellulose esters are considered to have a maximum degree of substitution of 3.0. A DS of 3.0 indicates that there are 3.0 reactive hydroxyl groups in cellulose that can be derivatized. Native cellulose is a large polysaccharide with a degree of polymerization from 700-2,000, and thus the assumption that the maximum DS is 3.0 is approximately correct. However, as the degree of polymerization is lowered, the end groups of the polysaccharide backbone become relatively more important.

Table 1 gives the DS_{Max} at various degrees of polymerization. Mathematically, a degree of polymerization of 401 is required in order to have a maximum DS of 3.00. As the table indicates, the increase in DS_{Max} that occurs with a decrease in DP is slow, and for the most part, assuming a maximum DS of 3.00 is acceptable. However, once the DP is low enough, for example a DP of 21, then it becomes appropriate to use a different maximum DS for all calculations.

TABLE 1
Effect of DS_{Max} on DP.

| DP | DS_{Max} |
|---|---|
| 1 | 5.00 |
| 2 | 4.00 |
| 3 | 3.67 |
| 4 | 3.50 |
| 5 | 3.40 |
| 6 | 3.33 |
| 7 | 3.29 |
| 8 | 3.25 |
| 9 | 3.22 |
| 10 | 3.20 |
| 11 | 3.18 |
| 12 | 3.17 |
| 13 | 3.15 |
| 14 | 3.14 |
| 15 | 3.13 |
| 16 | 3.13 |
| 17 | 3.12 |
| 18 | 3.11 |
| 19 | 3.11 |
| 20 | 3.10 |
| 21 | 3.10 |
| 22 | 3.09 |
| 23 | 3.09 |
| 24 | 3.08 |
| 25 | 3.08 |
| 50 | 3.04 |
| 75 | 3.03 |
| 100 | 3.02 |
| 134 | 3.01 |
| 401 | 3.00 |

Calculation of Weight Percent Hydroxyl (Wt % OH), Weight Percent Acetyl (Wt % Ac), Weight Percent Propionyl (Wt % Pr), and Weight Percent Butyryl (Wt. % Bu)

We note that wt. % substitutions may be calculated from degree of substitution (DS) values, according to the following:

Wt % Butyryl of a CAB is calculated using the following equation:

Wt%Bu=(DS_{Bu}*MW_{Bu})/((DS_{Ac}*MW_{AcKet})+(DS_{Bu}*MW_{BuKet})+MW_{anhydroglu})

Wt % Acetyl of a CAB is calculated using the following equation:

Wt%Ac=(DS_{Ac}*MW_{Ac})/((DS_{Ac}*MW_{AcKet})+(DS_{Bu}*MW_{BuKet})+MW_{anhydroglu})

Wt % Hydroxyl of a CAB is calculated using the following equation:

Wt%OH=(DS_{Max}−DS_{Ac}−DS_{Bu})*MW_{OH}/((DS_{Ac}*MW_{AcKet})+(DS_{Bu}*MW_{BuKet})+MW_{anhydroglu})

Wt % Butyryl of a CAP is calculated using the following equation:

Wt%Bu=(DS_{Pr}*MW_{Pr})/((DS_{Ac}*MW_{AcKet})+(DS_{Pr}*MW_{PrKet})+MW_{anhydroglu})

Wt % Acetyl of a CAP is calculated using the following equation:

Wt%Ac=(DS_{Ac}*MW_{Ac})/((DS_{Ac}*MW_{AcKet})+(DS_{Pr}*MW_{PrKet})+MW_{anhydroglu})

Wt % Hydroxyl of a CAB is calculated using the following equation:

Wt%OH=(DS_{Max}−DS_{Ac}−DS_{Pr})*MW_{OH}/((DS_{Ac}*MW_{AcKet})+(DS_{Pr}*MW_{PrKet})+MW_{anhydroglu})

Where MW_{Bu} means the molecular weight of a butyryl group (71.099); MW_{Ac} means the molecular weight of an acetyl group (43.045); MW_{PR} means the molecular weight of a propionyl group (57.072); MW_{OH} means the molecular weight of a hydroxyl group (17.007); MW_{BuKet} means the molecular weight of a butyryl ketene (70.091); MW_{AcKet} means the molecular weight of an acetyl ketene (42.037); MW_{PrKet} means the molecular weight of a propionyl ketene (56.064); MW_{anhydroglu} means the molecular weight of an anhydroglucose unit (162.141).

Evaluation of Cellulose Esters by Differential Scanning Calorimetry (DSC)

Differential scanning calorimetry (TA Instruments DSC 2920 with a typical sample size of 8 to 10 mg and heating rate of 20° C./min, second scan, after heating to 220-250° C. (depending on sample stability) at 20° C./min, and cooling to below 0° C.) was employed to determine glass transition temperatures, Tg's.

### Evaluation of Cellulose Esters by Inherent Viscosity (IV)

The inherent viscosity (IV) of the cellulose esters, except where indicated otherwise, were determined by measuring the flow time of a solution of known polymer concentration and the flow time of a solvent-blank in a capillary viscometer, and then calculating the IV.

### IV is Defined by the Following Equation 7:

$${( n )}_{0.50 \%}^{25 ° C .} = \frac{ln \frac{{t}_{s}}{{t}_{0}}}{C} \qquad Equation 7$$

where:
(n)=Inherent Viscosity at 25° C. at a polymer concentration of 0.50 g/100 mL of solvent.
In=Natural logarithm
tₛ=Sample flow time
tₒ=Solvent-blank flow time
C=Concentration of polymer in grams per 100 mL of solvent =0.50

Samples were prepared to a concentration of 0.50 g per 100 mL of solvent (60% phenol and 40% 1,1,2,2-tetrachloroethane by weight, also described herein as “PM95”). The sample (0.25 g) was weighed into a culture tube containing a stir bar. 50.0 mL of 60% phenol and 40% 1,1,2,2-tetrachloroethane by weight (also described in the application as “PM95”) is added. The mixture was placed in a heater and heated with stirring (300 rpm) to 125° C. (7 minutes to reach the target temperature and 15 minute hold at 125° C.). The sample was allowed to cool to room temperature (25° C.) and was then filtered and placed in the viscometer (Model AVS 500-Schott America, Glass & Scientific Products, Inc., Yonkers, N.Y.). IV was calculated according to the equation above.

### Evaluation of Cellulose Esters by Gel Permeation Chromatography (GPC)

The molecular weight distributions of cellulose ester samples were determined by gel permeation chromatography (GPC) using the method listed below.

The molecular weight distributions of cellulose ester samples indicated as being tested by GPC with THF as a solvent were determined at ambient temperature (about 25° C.) in Burdick and Jackson GPC-grade THF stabilized with BHT, at a flow rate of 1 mL/min. Sample solutions were prepared by dissolution of about 50 mg of cellulose ester in 10 mL of THF, to which 10 microliter of toluene was added as a flow-rate marker. An autosampler was used to inject 50 microliter of each solution onto a Polymer Laboratories PLgel™ column set consisting of a 5 micron Guard, a Mixed-C™ and an Oligopore™ column in series. The eluting cellulose ester was detected by differential refractometry, with the detector cell held at 30° C. The detector signal was integrated and a calibration curve was determined with a set of eighteen nearly monodisperse polystyrene standards with molecular weight from 266 to 3,200,000 g/mole and 1-phenylhexane at 162 g/mole. The molecular weight distributions and averages are reported either as equivalent polystyrene values or as true molecular weights calculated by means of a universal calibration procedure with the following parameters:

K_{PS}=0.0128 a_{PS}=0.712 (reported the Polymer Handbook, Fourth Edition, Eds. Brandrup, J.; Immergut, E. H.; Grulke, E. A.; John Wiley & Sons, Inc., New York, 1999)
K_{CE}=0.00757 a_{CE}=0.842 (corrections factors used to convert from polystyrene equivalents to absolute molecular weight of a cellulose ester)

Certain embodiments of the present invention are further illustrated by the following examples of preferred embodiments, although it will be understood that these examples are included merely for purposes of illustration and are not intended to limit the scope of the invention unless otherwise specifically indicated.

### Lab Scale Film Casting

Cellulose ester films were cast from solutions of a cellulose ester dissolved in an appropriate solvent, such as cyclopentanone (CP), methyl isobutyl ketone (MIBK), toluene, N,N-dimethylformamide (DMF), N,N-dimethylacetamide (DMAc), NMP and mixtures of solvents including methylene chloride/methanol (85/15, wt/wt), methylene chloride/methanol (90/10, wt/wt), and methylene chloride/methanol/n-butanol (85/14/1, wt/wt), (not limited in these solvents and solvent mixtures) at about 5 to 40 weight % solids onto a smooth surface (for example glass, stainless steel, aluminum, or Teflon) using a casting blade. The solvent was allowed to evaporate and the film was peeled from the surface.

### General Film Casting Conditions

CAP films in Examples 24 to 72 were prepared under the following conditions. CAP samples were dried overnight in a vacuum oven to remove water prior to dope preparation. Dried CAP (21.6 g) was added to a four ounce wide mouth jar. Triphenylphosphate (2.4 g) was then added to the jar. A solvent mixture containing methylene chloride, methanol, and n-butanol (85/14/1, wt/wt/wt) added to the jar to dissolve the CAP. The amount of the solvent mixture was adjusted to reach the target weight percent of solids in the system. Typical solids levels were 14, 12, 10, 8, and 6 wt %. The CAP, TPP, CH₂Cl₂, MeOH, n-BuOH mixture was mixed on rollers until all of the cellulose was dissolved to form a clear dope. A casting knife (i.e. doctor blade) was used for controlling the film thickness during film casting. A portion of the dope was poured onto a glass plate between the blade and the sides of a casting knife and the film was immediately cast by pulling the casting knife down the glass plate. The glass plate and wet film was covered with a lid, about ¼ inch deep, to retard the rate of solvent evaporation. After one hour, the lid was removed and the film was removed from the glass plate by carefully lifting one corner and slightly pulling to allow the film to release from the glass plate without introducing excess stress to the film.

### General Film Stretching Conditions

CAP films were cut into about 4 inch×4 inch squares using a paper cutter. The films were placed in the grips of a Brückner film stretching machine. The stretching conditions were set using the instruments software package. Typically the films were stretched at temperatures ranging between 10 to 30° C. above the T_{g} of the film as determined by the initial DSC scan of the cast film. The films were then stretched using the target temperature setpoints, soak times, stretch ratios, and stretching times.

### Birefringence Measurements

A Metricon® 2010 Prism Coupler was used to measure the birefringence values. This instrument is equipped with three laser sources with different wavelengths of 633, 827 and 1542 nm, respectively.

### Birefringence Calculations

Birefringence values can also be calculated from retardation data measured on an ellipsometer (such as an M-2000/EC-400 Spectroscopic Ellipsometer from J. A. Woollam Co., Inc.) according to the equation 8:

Δn=Rₜₕ/(1000×DFT) Equation 8

where Δn=birefringence,
Rₜₕ=Through retardation of a film as measured by an ellipsometer, and
DFT=Dry Film Thickness in microns.

### Through Retardation (Rₜₕ) Calculations

Through Retardation (Rₜₕ) values can also be calculated from Metricon birefringence data according to the equation 9:

Rₜₕ=Δn×1000×DFT Equation 9

where Δn=birefringence,
Rₜₕ=Through retardation of a film as measured by an ellipsometer, and
DFT=Dry Film Thickness in microns.

### Examples

### Preparation of High DS_{OH} Cellulose Acetate Butyrates and Cellulose Acetate Propionates

### Examples 1-20 and Comparative Examples 21-23

A cellulose ester dope is prepared by adding a cellulose ester (such as CAB-381-20, CAP-482-20, CAP-141-20, all commercially available from Eastman Chemical Company, Kingsport, Tenn.) to an appropriate reaction vessel (for example a 1000-mL 3-necked round bottomed flask equipped with an overhead stirrer and a thermocouple and a temperature controller) containing an mixture of acetic acid, propionic acid, butyric acid, and water. The mixture is stirred and heated to an appropriate temperature, typically between 40° C. and 85° C. until the cellulose esters is dissolved and a clear, viscous mixture is produced. A catalyst mixture comprised of sulfuric acid, butyric acid and/or propionic acid, and acetic acid is added to the cellulose ester dope. A hydrolysis mixture comprising of butyric acid and/or propionic acid, acetic acid, water, and optionally sulfuric acid is added in an appropriate manner (for example, dropwise, in portions, as a steady stream, or in a single addition) to the cellulose ester dope. Care is taken to add the hydrolysis mixture at a slow enough rate to prevent precipitation of the cellulose ester. Some localized precipitation may be observed, but the cellulose ester typically redissolves quickly with stirring. The mixture is heated and stirred for an appropriate length of time to produce a cellulose ester with the desired DS_{OH}, Mₙ, and IV. The hydrolysis reaction is stopped by neutralizing the sulfuric acid by adding an excess of a metal acetate salt. The neutralized dope is then optionally filtered through a pad of glass wool in a coarse fritted funnel. The desired product is precipitated by pouring a thin stream of dope into water in a stainless steel bucket equipped with baffles and with rapid mixing using an Omni homogenizer/mixer. The cellulose ester is placed in a nylon bag and is washed with water (typically deionized or demineralized) overnight. The washed cellulose ester is dewatered by filtration on a fritted funnel, and then is dried in vacuo at between 40 to 65° C. Analytical data for cellulose esters described in the examples and comparative examples are presented in Tables 2-5.

TABLE 2

| Example | | | | | Wt % | Wt % | Wt % | Wt % |
|---|---|---|---|---|---|---|---|---|
| # | DS_{Ac} | DS_{Pr} | DS_{Bu} | DS_{OH} | Ac | Pr | Bu | OH |
| 1 | 0.64 | 0 | 1.38 | 0.98 | 9.64 | — | 34.09 | 5.83 |
| 2 | 0.9 | 0 | 1.65 | 0.45 | 12.27 | — | 36.87 | 2.42 |
| 3 | 0.74 | 0 | 1.5 | 0.76 | 10.68 | — | 35.47 | 4.33 |
| 4 | 0.54 | 0 | 1.28 | 1.18 | 8.47 | — | 32.93 | 7.31 |
| 5 | 0.93 | 0 | 1.64 | 0.43 | 12.66 | — | 36.58 | 2.31 |
| 6 | 0.87 | 0 | 1.61 | 0.52 | 12.02 | — | 36.45 | 2.84 |
| 7 | 0.81 | 0 | 1.56 | 0.63 | 11.41 | — | 36.02 | 3.51 |
| 8 | 0.71 | 0 | 1.46 | 0.83 | 10.38 | — | 35.01 | 4.80 |
| 9 | 0.49 | 0 | 1.18 | 1.33 | 7.95 | — | 31.41 | 8.52 |
| 10 | 0.06 | 2.42 | 0 | 0.52 | 0.86 | 45.61 | — | 2.94 |
| 11 | 0.06 | 2.35 | 0 | 0.59 | 0.87 | 44.88 | — | 3.39 |
| 12 | 0.11 | 1.86 | 0 | 1.03 | 1.75 | 38.88 | — | 6.46 |
| 13 | 0.08 | 2.35 | 0 | 0.57 | 1.16 | 44.75 | — | 3.26 |
| 14 | 0.05 | 2.58 | 0 | 0.37 | 0.70 | 47.26 | — | 2.04 |
| 15 | 0.07 | 1.87 | 0.07 | 0.99 | NA | NA | NA | NA |
| 16 | 0.07 | 1.89 | 0.07 | 0.97 | NA | NA | NA | NA |
| 17 | 0.14 | 1.78 | 0 | 1.08 | 2.25 | 37.66 | 0 | 6.86 |
| 18 | 0.17 | 1.54 | 0 | 1.29 | 2.86 | 34.15 | 0 | 8.58 |
| 19 | 0.53 | 1.45 | 0 | 1.02 | 8.59 | 30.91 | 0 | 6.53 |
| 20 | 1.38 | 0.62 | 0 | 1 | 23.3 | 13.77 | 0 | 6.67 |

TABLE 3

| | IV | IV | | | |
|---|---|---|---|---|---|
| Example # | (PM95) | (Acetone) | Mₙ | T_{g} | Δn⁶³³ |
| 1 | 1.508 | NA | NA | 165.18 | −0.0044 |
| 2 | NA | NA | 52986 | NA | NT |
| 3 | NA | NA | 56162 | NA | −0.0034 |
| 4 | 1.533 | NA | 39306 | NA | −0.0058 |
| 5 | NA | NA | NA | NA | −0.0013 |
| 6 | NA | NA | NA | NA | −0.0023 |
| 7 | NA | NA | NA | NA | −0.0028 |
| 8 | NA | NA | NA | NA | −0.0033 |
| 9 | NA | NA | NA | NA | −0.0035 |
| 10 | 1.43 | NA | 39768 | 153.65 | −0.0023 |
| 11 | 1.434 | NA | 36896 | 154.68 | −0.0025 |
| 12 | 1.535 | NA | 29887 | 181.23 | −0.0039 |
| 13 | 0.794 | NA | 23485 | 151.43 | −0.0011 |
| 14 | 1.535 | NA | 50662 | 136.89 | −0.0006 |
| 15 | 1.101 | NA | 26611 | 176.39 | −0.0031 |
| 16 | 1.104 | NA | 24707 | 174.4 | −0.0026 |
| 17 | 1.639 | 1.62 | 12189 | 183.53 | NA |
| 18 | 1.579 | 0.22** | 9387 | 191.87 | NT |
| 19 | NA | NA | 57620* | 183.15 | NT |
| 20 | NA | NA | 68057* | 198.15 | NT |

*GPC PS equivalents in NMP
**Not completely soluble
NA = not applicable

TABLE 4

| Comparative | | | | | Wt % | Wt % | Wt % | Wt % |
|---|---|---|---|---|---|---|---|---|
| Example # | DS_{Ac} | DS_{Pr} | DS_{Bu} | DS_{OH} | Ac | Pr | Bu | OH |
| 21 | 1.01 | 0 | 1.71 | 0.28 | 13.40 | NA | 37.16 | 1.47 |
| 22 | 0.05 | 2.73 | 0 | 0.22 | 0.68 | 48.67 | NA | 1.18 |
| 23 | 0.04 | 2.63 | 0 | 0.33 | 0.55 | 47.81 | NA | 1.80 |

NA = not applicable

TABLE 5

| Comparative | IV | IV | | | |
|---|---|---|---|---|---|
| Example # | (PM95) | (Acetone) | Mₙ | T_{g} | Δn⁶³³ |
| 21 | NA | NA | NA | NA | −0.001 |
| 22 | 1.427 | NA | 47214 | 141.26 | −0.0003 |
| 23 | 1.412 | NA | 42792 | 146.31 | −0.0006 |

NA = not applicable

### Examples 13-14

A CAP dope was prepared by adding 250 grams (about 319.67 g/mol, 0.78 mol, based on anhydroglucose units, Eastman Chemical Company, Lot # BP-04951-B) of CAP-482-20, 1226.6 grams (20.43 mol) of acetic acid to a 5000-mL 3-necked round bottomed flask equipped with an overhead stirrer and a thermocouple connected to a J-Kem temperature controller and stirring the mixture at 55° C. until the solid dissolves into a clear dope or a slightly cloudy, viscous mixture. The dope was allowed to cool to room temperature with stirring overnight. The dope was heated to 70° C. and a catalyst solution comprised of 253.6 grams (14.07 mol) of demineralized water and 3.775 grams (0.038 mol) of sulfuric acid was added to the CAP dope. A hydrolysis solution comprising 695 grams (11.57 mol) of acetic acid, 695 grams (38.61 mol) of demineralized water was added to an addition funnel and then was added dropwise to the CAP dope/catalyst solution mixture. Care was taken to add the water solution at a slow enough rate to prevent precipitation of the CAP. Some localized precipitation may be observed, but the CAP should quickly redissolve with stirring. The mixture was stirred at 70° C. for an appropriate amount of time to produce a CAP with the following characteristics; DS_{Ac}=0.08; DS_{Pr}=2.35; DS_{OH}=0.57; IV=0.794; Mₙ=23485; M_{w}=59972; M_{w}/Mₙ=2.55; T_{g}=151.43 or DS_{Ac}=0.05; DS_{Pr}=2.58; DS_{OH}=0.37; IV=1.535; Mₙ=50662; M_{w}=149572; M_{w}/Mₙ=2.95; T_{g}=136.89.

A neutralization solution comprised of an alkali metal salt or an alkaline earth metal salt (preferably an acetate), water, and acetic acid was added to stop the hydrolysis reaction.

The neutralized dope was transferred in portions to a 250-mL addition funnel. The CAP was slowly added in a thin stream to water in a stainless steel bucket equipped with baffles and was rapidly mixed using an Omni homogenizer/mixer. The CAP is isolated as a white, clumpy solid. Each sample was placed in a nylon bag and was washed with demineralized water overnight, was dewatered by filtration on a fritted funnel, and then was dried in vacuo at approximately 50° C.

### Examples 15-16

A CAP dope was prepared by adding 250 grams (about 319.67 g/mol, 0.78 mol, based on anhydroglucose units, Eastman Chemical Company, Lot # BP-04951-B) of CAP-482-20, 1226.6 grams (13.92 mol) of butyric acid to a 5000-mL 3-necked round bottomed flask equipped with an overhead stirrer and a thermocouple connected to a J-Kem temperature controller and stirring the mixture at 55° C. until the solid dissolved into a clear dope or a slightly cloudy, viscous mixture. The dope was allowed to cool to room temperature with stirring overnight. The dope was heated to 70° C. and a catalyst solution comprised of 96.4 grams of butyric acid (1.09 mol) and 3.775 grams (0.038 mol) of sulfuric acid was added to the CAP dope. A hydrolysis solution comprising 1200 grams (19.98 mol) of acetic acid, 1200 grams (66.59 mol) of demineralized water was added to an addition funnel and then was added dropwise to the CAP dope/catalyst solution mixture. Care was taken to add the water solution at a slow enough rate to prevent precipitation of the CAP. Some localized precipitation may be observed, but the CAP should quickly redissolve with stirring. The mixture was stirred at 70° C. for an appropriate amount of time to produce a cellulose acetate propionate butyrate with the following characteristics; DS_{Ac}=0.07; DS_{Pr}=1.87; DS_{Bu}=0.07; DS_{OH}=0.99; IV=1.101; Mₙ=26611; M_{w}=81016; M_{w}/Mₙ=3.04; T_{g}=176.39 or DS_{Ac}=0.07; DS_{Pr}=1.89; DS_{Bu}=0.07; DS_{OH}=0.97; IV=1.104; Mₙ=24707; M_{w}=76888; M_{w}/Mₙ=3.11; T_{g}=174.4.

A neutralization solution comprised of an alkali metal salt or an alkaline earth metal salt (preferably an acetate), water, and acetic acid was added to stop the hydrolysis reaction.

The neutralized dope was transferred in portions to a 250-mL addition funnel. The CAPB was slowly added in a thin stream to water in a stainless steel bucket equipped with baffles and was rapidly mixed using an Omni homogenizer/mixer. The CAPB was isolated as a white to pale yellow, clumpy solid. Each sample was placed in a nylon bag and was washed with demineralized water overnight, was dewatered by filtration on a fritted funnel, and then was dried in vacuo at approximately 50° C.

### Birefringence and Retardation Data

Birefringence data are presented in Tables 2-5. Retardation, Rₜₕ, values are dependent on film thickness and have been calculated and are presented in see Table 6, for several film thicknesses: 40, 60, 80, 100, and 120 microns.

The effect of stretching on the retardation (Rₜₕ and Rₑ) of examples of the inventive high hydroxyl cellulose ester films are presented in Tables 8-13. The stretch conditions employed (for example temperature, stretch ratio, and pre-heating (that is soak time)), the composition of the films, (for example the DS_{OH}, DS_{Pr}, DS_{Ac}, DS_{Bu}, molecular weight, and T_{g} of the high hydroxyl cellulose ester, the plasticizer amount and type of plasticizer used, and the impact of any additional additives), and the environmental conditions (for example ambient temperature and relative humidity) may impact the Rₜₕ and Rₑ values of the resultant films. It should also be noted that the stretch conditions, film compositions, and environmental conditions can be adjusted to optimize the retardation values (Rₜₕ and Rₑ) resulting from stretching the film. Unexpectedly the inventive high hydroxyl cellulose esters and films allow one to produce a much higher than expected Rₜₕ value than would be expected based on the results of conventional commercial cellulose esters, and as a result a lower gauge film thickness (<80 microns, typically 40-60 microns) can be used to reach commercially viable retardation (i.e. Rₜₕ) values, for example Rₜₕ of about −240 to −300, for a one sided retardation film for VA mode LCD's without the use of expensive retardation enhancing additives.

TABLE 6

| | | Sample | | | | | |
|---|---|---|---|---|---|---|---|
| | | Description | | | | | |
| | | Film | Calculated from Δn⁶³³ | | | | |
| | | Thickness in | Rₜₕ | Rₜₕ | Rₜₕ | Rₜₕ | Rₜₕ |
| | Δn⁶³³ | μm | 40 | 60 | 80 | 100 | 120 |
| Example # | | | | | | | |
| 1 | −0.0044 | CAB | −176 | −264 | −352 | −440 | −528 |
| 3 | −0.0034 | CAB | −136 | −204 | −272 | −340 | −408 |
| 4 | −0.0058 | CAB | −232 | −348 | −464 | −580 | −696 |
| 5 | −0.0013 | CAB | −52 | −78 | −104 | −130 | −156 |
| 6 | −0.0023 | CAB | −92 | −138 | −184 | −230 | −276 |
| 7 | −0.0028 | CAB | −112 | −168 | −224 | −280 | −336 |
| 8 | −0.0033 | CAB | −132 | −198 | −264 | −330 | −396 |
| 9 | −0.0035 | CAB | −140 | −210 | −280 | −350 | −420 |
| 10 | −0.0023 | CAP | −92 | −138 | −184 | −230 | −276 |
| 11 | −0.0025 | CAP | −100 | −150 | −200 | −250 | −300 |
| 12 | −0.0039 | CAP | −156 | −234 | −312 | −390 | −468 |
| 13 | −0.0011 | CAP | −44 | −66 | −88 | −110 | −132 |
| 14 | −0.0006 | CAP | −24 | −36 | −48 | −60 | −72 |
| 15 | −0.0031 | CAPB | −124 | −186 | −248 | −310 | −372 |
| 16 | −0.0026 | CAPB | −104 | −156 | −208 | −260 | −312 |
| Comparative | | | | | | | |
| Example # | | | | | | | |
| CAB-381-20 | −0.0008 | CAB | −32 | −48 | −64 | −80 | −96 |
| CAP-482-20 | −0.0008 | CAP | −32 | −48 | −64 | −80 | −96 |
| 21 | −0.001 | CAB | −40 | −60 | −80 | −100 | −120 |
| 22 | −0.0003 | CAP | −12 | −18 | −24 | −30 | −36 |
| 23 | −0.0006 | CAP | −24 | −36 | −48 | −60 | −72 |

TABLE 7
High Hydroxyl Cellulose Esters used
in Film Stretching Experiments

| High Hydroxyl | | | Plasti- | | |
|---|---|---|---|---|---|
| Cellulose | | CE | cizer | | Solvent |
| Ester | Films | Level | Level | Pz Type | System |
| Examples 1-16 | Examples 1-16 | 2 to 3 | 0 | None | A |
| | Films | | | | |
| Example 17 | Examples 24 to 33 | 10 | 11 | TPP | B |
| Example 18 | Examples 34 to 47 | 8 | 11 | TPP | B |
| Example 19 | Examples 48 to 59 | 10 | 11 | TPP | B |
| Example 20 | Examples 60 to 72 | 10 | 11 | TPP | B |

Solvent System A = cyclopentanone
Solvent System B = methylene chloride/methanol/n-butanol (84/15/1, wt/wt/wt)
CE Level means the weight % of the cellulose ester in the film casting dope based on the total weight of the film casting dope.
Plasticizer Level means the weight % of the plasticizer in the film casting dope based on the weight of cellulose ester in the film casting dope.

TABLE 8
Film Stretching Data for CE Example 17.

| | | | | | Initial | | | | | | | Stretched | |
|---|---|---|---|---|---|---|---|---|---|---|---|---|---|
| | | | | | Rth | | | | | | | Rth | |
| | Initial | Initial | Initial | | Norm'd | Temp | Stretch | Stretch | Stretched | Stretched | Stretched | Norm'd to | |
| Example | Re | Rth | Thickness | Initial | to 60 | Setpoint | Ratio | Ratio | Re | Rth | Thickness | 60 μm | |
| # | nm | nm | μm | Calc'd Δn | μm | ° C. | MD | TD | nm | nm | μm | DFT | Calc'd Δn |
| 24 | NA | NA | NA | NA | NA | 180 | 1.5 | 1 | | | | | |
| 25 | 0.39 | −181 | NA | NA | NA | 185 | 1.5 | 1 | 117 | −182 | 46 | −237.4 | −0.004 |
| 26 | 1.84 | −218 | 85 | −0.00256 | −153.9 | 185 | 1 | 1 | 1.347 | −128 | 74 | −103.8 | −0.0017 |
| 27 | 0.24 | −242 | NA | NA | NA | 185 | 1.25 | 1 | 84 | −197 | 64 | −184.7 | −0.0031 |
| 28 | 0.77 | −218 | 75 | −0.00291 | −174.4 | 185 | 1.125 | 1 | 40 | −149 | 67 | −133.4 | −0.0022 |
| 29 | 2.61 | −207 | 68 | −0.00304 | −182.6 | 185 | 1.25 | 1.15 | 42 | −189 | 52 | −218.1 | −0.0036 |
| 30 | −0.14 | −226 | 73 | −0.0031 | −185.8 | 185 | 1.25 | 1.2 | 23 | −207 | 55 | −225.8 | −0.0038 |
| 31 | −0.21 | −215 | NA | NA | NA | 195 | 1 | 1 | 1.4 | −97 | 64 | −90.9 | −0.0015 |
| 32 | 4.93 | −188 | 72 | −0.00261 | −156.7 | 195 | 1.5 | 1 | 98 | −145 | 46 | −189.1 | −0.0032 |
| 33 | 0.59 | −232 | 70 | −0.00331 | −198.9 | 195 | 1.5 | 1.3 | 45 | −148 | 36 | −246.7 | −0.0041 |

TABLE 9
Film Stretching Data for CE Example 18.

| | | | | | Initial | | | | | | | Stretched | |
|---|---|---|---|---|---|---|---|---|---|---|---|---|---|
| | | | | | Rth | | | | | | | Rth | |
| | Initial | Initial | Initial | | Norm'd | Temp | Stretch | Stretch | Stretched | Stretched | Stretched | Norm'd to | |
| Example | Re | Rth | Thickness | Initial | to 60 | Setpoint | Ratio | Ratio | Re | Rth | Thickness | 60 μm | |
| # | nm | nm | μm | Calc'd Δn | μm | ° C. | MD | TD | nm | nm | μm | DFT | Calc'd Δn |
| 34 | 2.9 | −304 | 83 | −0.00366 | −219.8 | 187 | 1.35 | 1.24 | 50 | −252 | 58 | −260.7 | −0.0043 |
| 35 | 5.4 | −295 | 86 | −0.00343 | −205.8 | 187 | 1.35 | 1.24 | 51.4 | −261 | 55 | −284.7 | −0.0047 |
| 36 | 1.2 | −271 | 89 | −0.00304 | −182.7 | 187 | 1.35 | 1.24 | 50 | −234 | 53 | −264.9 | −0.0044 |
| 37 | −0.35 | −257.5 | 78 | −0.0033 | −198.1 | 187 | 1.35 | 1.24 | 57 | −237 | 50 | −284.4 | −0.0047 |
| 38 | 9.7 | −284 | 80 | −0.00355 | −213 | 187 | 1.35 | 1.24 | 48 | −251 | 48 | −313.8 | −0.0052 |
| 39 | 8.9 | −318 | 90 | −0.00353 | −212 | 187 | 1.35 | 1.24 | 47 | −260 | 55 | −283.6 | −0.0047 |
| 40 | 0.37 | −354 | 78 | −0.00454 | −272.3 | 187 | 1.35 | 1.24 | 47 | −296 | 50 | −355.2 | −0.0059 |
| 41 | 0.31 | −330 | 85 | −0.00388 | −232.9 | 187 | 1.35 | 1.24 | NA | NA | NA | NA | NA |
| 42 | 3.7 | −301 | 80 | −0.00376 | −225.8 | 187 | 1.35 | 1.24 | 49 | −241 | 47 | −307.7 | −0.0051 |
| 43 | 3.17 | −322 | 80 | −0.00403 | −241.5 | 187 | 1.35 | 1.24 | 49 | −253 | 53 | −286.4 | −0.0048 |
| 44 | 1 | −306 | 85 | −0.0036 | −216 | 187 | 1.35 | 1.24 | 52 | −250 | 49 | −306.1 | −0.0051 |
| 45 | 1.4 | −290 | 78 | −0.00372 | −223.1 | 187 | 1.35 | 1.24 | 49 | −237 | 50 | −284.4 | −0.0047 |
| 46 | 0.4 | −326 | 79 | −0.00413 | −247.6 | 187 | 1.35 | 1.24 | NA | NA | NA | NA | NA |
| 47 | 1.1 | −297 | 75 | −0.00396 | −237.6 | 187 | 1.35 | 1.24 | 50 | −254 | 46 | −331.3 | −0.0055 |

TABLE 10
Film Stretching Data for CE Example 19.

| | | | | | Initial | | | | | | | Stretched | |
|---|---|---|---|---|---|---|---|---|---|---|---|---|---|
| | | | | | Rth | | | | | | | Rth | |
| | Initial | Initial | Initial | | Norm'd | Temp | Stretch | Stretch | Stretched | Stretched | Stretched | Norm'd to | |
| Example | Re | Rth | Thickness | Initial | to 60 | Setpoint | Ratio | Ratio | Re | Rth | Thickness | 60 μm | |
| # | nm | nm | μm | Calc'd Δn | μm | ° C. | MD | TD | nm | nm | μm | DFT | Calc'd Δn |
| 48 | 0.58 | −241 | 75 | −0.00321 | −192.8 | 173 | 1.35 | 1.24 | 30.63 | −164.44 | 58 | −170.1 | −0.0028 |
| 49 | 1.34 | −175.5 | 85 | −0.00206 | −123.9 | 173 | 1.35 | 1.24 | 31 | −164 | 61 | −161.3 | −0.0027 |
| 50 | 1.31 | −219 | 86 | −0.00255 | −152.8 | 173 | 1.35 | 1.24 | 36 | −174 | 60 | −174 | −0.0029 |
| 51 | 0.52 | −206 | 84 | −0.00245 | −147.1 | 173 | 1.35 | 1.24 | 34 | −174 | 52 | −200.8 | −0.0033 |
| 52 | 0.28 | −204 | 88 | −0.00232 | −139.1 | 173 | 1.35 | 1.24 | 34.5 | −168 | 60 | −168 | −0.0028 |
| 53 | 0.7 | −210.9 | 78 | −0.0027 | −162.2 | 173 | 1.35 | 1.24 | 35 | −171.5 | 55 | −187.1 | −0.0031 |
| 54 | 2.51 | −179.5 | 99 | −0.00181 | −108.8 | 173 | 1.35 | 1.24 | 34 | −171 | 64 | −160.3 | −0.0027 |
| 55 | 4.1 | −166 | 91 | −0.00182 | −109.5 | 173 | 1.35 | 1.24 | 35 | −168 | 52 | −193.8 | −0.0032 |
| 56 | 0.1 | −192.3 | 82 | −0.00235 | −140.7 | 173 | 1.35 | 1.24 | 35.5 | −171 | 57 | −180 | −0.003 |
| 57 | 0.44 | −204.3 | 94 | −0.00217 | −130.4 | 173 | 1.35 | 1.24 | 38.5 | −178 | 65 | −164.3 | −0.0027 |
| 58 | NA | −181 | 91 | −0.00199 | −119.3 | 173 | 1.35 | 1.24 | 35 | −165 | 64 | −154.7 | −0.0026 |
| 59 | NA | −219 | 84 | −0.00261 | −156.4 | 173 | 1.35 | 1.24 | 35 | −175 | 65 | −161.5 | −0.0027 |

TABLE 11
Film Stretching Data for CE Example 20.

| | | | | | Initial | | | | | | | Stretched | |
|---|---|---|---|---|---|---|---|---|---|---|---|---|---|
| | | | | | Rth | | | | | | | Rth | |
| | Initial | Initial | Initial | | Norm'd | Temp | Stretch | Stretch | Stretched | Stretched | Stretched | Norm'd to | |
| Example | Re | Rth | Thickness | Initial | to 60 | Setpoint | Ratio | Ratio | Re | Rth | Thickness | 60 μm | |
| # | nm | nm | μm | Calc'd Δn | μm | ° C. | MD | TD | nm | nm | μm | DFT | Calc'd Δn |
| 60 | 2.41 | −232 | 75 | −0.00309 | −185.6 | 188 | 1.35 | 1.24 | 43 | −195 | 48 | −243.8 | −0.0041 |
| 61 | 2.2 | −259 | 80 | −0.00324 | −194.3 | 188 | 1.35 | 1.24 | 38 | −200 | 50 | −240 | −0.004 |
| 62 | 1.3 | −247 | 76 | −0.00325 | −195 | 188 | 1.35 | 1.24 | NA | NA | NA | NA | NA |
| 63 | 3.87 | −278 | 85 | −0.00327 | −196.2 | 188 | 1.35 | 1.24 | 40 | −190 | 50 | −228 | −0.0038 |
| 64 | 4.3 | −259 | 80 | −0.00324 | −194.3 | 188 | 1.35 | 1.24 | 39 | −191 | 48 | −238.8 | −0.004 |
| 65 | 3.3 | −245 | 82 | −0.00299 | −179.3 | 188 | 1.35 | 1.24 | NA | NA | NA | NA | NA |
| 66 | 0.88 | −267 | 85 | −0.00314 | −188.5 | 188 | 1.35 | 1.24 | 39 | −203 | 52 | −234.2 | −0.0039 |
| 67 | 0.83 | −273 | 84 | −0.00325 | −195 | 188 | 1.35 | 1.24 | 37 | −208 | 49 | −254.7 | −0.0042 |
| 68 | 0.07 | −273 | 81 | −0.00337 | −202.2 | 188 | 1.35 | 1.24 | 34 | −197 | 48 | −246.3 | −0.0041 |
| 69 | 1.8 | −280 | 89 | −0.00315 | −188.8 | 188 | 1.35 | 1.24 | 36 | −215 | 56 | −230.4 | −0.0038 |
| 70 | 6.4 | −257 | 85 | −0.00302 | −181.4 | 188 | 1.35 | 1.24 | 40 | −195 | 50 | −234 | −0.0039 |
| 71 | 0.43 | −258 | 80 | −0.00323 | −193.5 | 188 | 1.35 | 1.24 | 34 | −194 | 46 | −253 | −0.0042 |
| 72 | 0.4 | −277 | 85 | −0.00326 | −195.5 | 188 | 1.35 | 1.24 | 34 | −201 | 50 | −241.2 | −0.004 |

Notes for Tables 8-11: “Initial Rₑ” is the Rₑ measured by ellipsometry before stretching or annealing; “Initial Rₜₕ” is the Rₜₕ measured by ellipsometry before stretching or annealing; “Initial Thickness” is the thickness of the film in microns as measured with a micrometer before stretching or annealing; “Initial Calc'd Δn” is the Δn value calculated from the Initial Rₜₕ measurements; “Initial Rₜₕ, Norm'd to 60 μm” is the calculated Rₜₕ value normalized to a dry film thickness of 60 μm; “Temp Setpoint” is the temperature setpoint in degrees Celsius for stretching; “Stretch Ratio, MD” is the stretch ratio in the machine direction and is presented in relation to no stretching at 1.0; “Stretch Ratio, TD” is the stretch ratio in the machine direction and is presented in relation to no stretching at 1.0; “Stretched Rₑ” is the Rₑ after stretching under the described conditions; “Stretched Rₜₕ” is the Rₜₕ after stretching under the described conditions; “Stretched Thickness” is the thickness of the film in microns after stretching as measured by a micrometer; “Stretched Rₜₕ, Norm'd to 60 μm DFT” is the calculated Rₜₕ value normalized to a dry film thickness of 60 μm; “Calc'd Δn” is the birefringence value of the stretched film calculated from the Stretched Rₜₕ.

TABLE 12
Additional Comparative Examples

| Comparative | | | | | | | | Film Thickness | Calculated |
|---|---|---|---|---|---|---|---|---|---|
| Example # | CE Type | DSAc | DSPr | DSBu | DSOH | Rth | Re | (microns) | Dn |
| 73 | CAP | 2 | 0.8 | 0 | 0.2 | 130 | 3 | 120 | −0.00108 |
| 74 | CAP | 1.9 | 0.7 | 0 | 0.4 | 160 | 4 | 120 | −0.00133 |
| 75 | CAP | 1.7 | 1 | 0 | 0.3 | 120 | 2 | 120 | −0.001 |
| 76 | CAP | 1.8 | 0.9 | 0 | 0.3 | 110 | 4 | 120 | −0.00092 |
| 77 | TAC | 2.8 | 0 | 0 | 0.2 | 55 | 10 | 120 | −0.00046 |
| 78 | CAP | 2 | 0.8 | 0 | 0.2 | 95 | 5 | 80 | −0.00119 |
| 79 | CAP | 2 | 0.8 | 0 | 0.2 | 140 | 6 | 140 | −0.001 |

Note:
In Table 12 Calculated □n values were generated according to the following equation:
Δn = Rₜₕ/(Film Thickness*−1000). “−1000” is used to convert the sign of the birefringence data to match that in this application. In the reference cited, the inventors determined Rₜₕ using a different calculation than we use, as a result the magnitude of Rₜₕ presented above of the same magnitude as the values we have measured, but the signs are opposite.

TABLE 13

| Comparative | | | Residual | | | | |
|---|---|---|---|---|---|---|---|
| Example # | Pz Type | Pz Amt | Solvent (in %) | Rₜₕ Calculation | Rₑ Calculation | Solvent Type | Reference |
| 73 | EPEG | 5 | 20 | Rₜₕ = ((nx + ny)/2 − nz)*d | Rₑ = (nx − ny)*d | MA 300 ET 45 | U.S. Pat. No. 6,503,581 |
| 74 | TPP | 7 | 15 | Rₜₕ = ((nx + ny)/2 − nz)*d | Rₑ = (nx − ny)*d | MA 350 ET 35 | U.S. Pat. No. 6,503,581 |
| | EPEG | 3 | | | | | |
| 75 | EPEG | 5 | 42 | Rₜₕ = ((nx + ny)/2 − nz)*d | Rₑ = (nx − ny)*d | MA 300 ET 45 | U.S. Pat. No. 6,503,581 |
| 76 | TPP | 8 | 65 | Rₜₕ = ((nx + ny)/2 − nz)*d | Rₑ = (nx − ny)*d | MA 300 AC 50 | U.S. Pat. No. 6,503,581 |
| | EPEG | 2 | | | | | |
| 77 | TPP | 15 | 80 | Rₜₕ = ((nx + ny)/2 − nz)*d | Rₑ = (nx − ny)*d | MC 450 ET 50 | U.S. Pat. No. 6,503,581 |
| 78 | EPEG | 5 | 40 | Rₜₕ = ((nx + ny)/2 − nz)*d | Rₑ = (nx − ny)*d | MA 300 ET 45 | U.S. Pat. No. 6,503,581 |
| 79 | EPEG | 5 | 28 | Rₜₕ = ((nx + ny)/2 − nz)*d | Rₑ = (nx − ny)*d | MA 300 ET 45 | U.S. Pat. No. 6,503,581 |

Notes for Table 13:
MA = methyl acetate;
ET = methanol;
MC = methylene chloride;
AC = acetone; as defined by U.S. Pat. No. 6,503,581

1. A film comprising:
70 to 100 weight percent of a cellulose acetate with a degree of substitution of hydroxyl groups from 0.40 to 2.00;
0 to 30 weight percent of a plasticizer; and
0 to 30 weight percent of an organic solvent,
wherein the weight percent is based on the total weight of the cellulose acetate, the plasticizer and the organic solvent and
wherein the film is unstretched.

2. The film of claim 1, wherein nx=ny and nx>nz and ny>nz.

3. The film of claim 1 wherein the degree of substitution of hydroxyl groups ranges from 0.65 to 2.00.

4. The film of claim 1 wherein the degree of substitution of hydroxyl groups ranges from 0.95 to 2.00.

5. The film of claim 1 wherein the degree of substitution of hydroxyl groups ranges from 1.01 to 2.00.

6. The film of claim 1 wherein the birefringence at 633 nm, Δn⁶³³, is less than zero to about −0.010.

7. The film of claim 1 wherein the birefringence at 633 nm, Δn⁶³³, ranges from equal to or less than −0.001 to about −0.010.

8. The film of claim 1 wherein the film has a thickness ranging from 3 microns to 300 microns.

9. The film of claim 1 wherein film thickness ranging from greater than 300 microns to 1000 microns.

10. The film of claim 1 wherein the plasticizer is selected from the group consisting of triphenyl phosphate (TPP), tricresyl phosphate, cresyl phenyl phosphate, octyl diphenyl phosphate, diphenyl biphenyl phosphate, trioctyl phosphate, tributyl phosphate, diethyl phthalate, dimethoxyethyl phthalate, dimethyl phthalate, dioctyl phthalate, dibutyl phthalate, di-2-ethyl hexyl phthalate, butyl benzyl phthalate, di-2-ethylhexyl phthalate, butyl benzyl phthalate, dibenzyl phthalate, triethyl citrate, acetyl trimethyl citrate, acetyl tributyl citrate. methyl phthalyl methyl glycolate, ethyl phthalyl ethyl glycolate (EPEG), propyl phthalyl propyl glycolate, butyl phthalyl butyl glycolate, octyl phthalyl octyl glycolate, methyl phthalyl ethyl glycolate, ethyl phthalyl methyl glycolate, ethyl phthalyl propyl glycolate, propyl phthalyl ethyl glycolate, methyl phthalyl propyl glycolate, methyl phthalyl butyl glycolate, ethyl phthalyl butyl glycolate, butyl phthalyl methyl glycolate, butyl phthalyl ethyl glycolate, propyl phthalyl butyl glycolate, butyl phthalyl propyl glycolate, methyl phthalyl octyl glycolate, ethyl phthalyl octyl glycolate, octyl phthalyl methyl glycolate, octyl phthalyl ethyl glycolate, butyl oleate, methyl acetyl ricinolate, dibutyl sebacate, triacetin, glucose pentapropionate, glucose pentaisobutyrate, glucose pentatbutyrate, fructose pentapropionate, fructose pentaisobutyrate, fructose pentatbutyrate, xylose tetrapropionate, xylose tetraisobutyrate, xylose tetrabutryate, xylitol pentapropionate, xylitol pentaisobutryate, xylitol pentabutyrate, mannitol hexapropionate, mannitol hexaisobutyrate, mannitol hexabutyrate and mixtures thereof.

11. The film of claim 1 where the organic solvent is selected from the group consisting of methylene chloride, chloroform, dichloroethane, 2,2,2-trifluoroethanol, 2,2,3,3-hexafluoro-1-propanol, 1,3-difluoro-2-propanol, 1,1,1,3,3,3-hexafluoro-2-methyl-2-propanol, 1,1,1,3,3,3-hexafluoro-2-propanol, 2,2,3,3,3-pentafluoro-1-propanol, methyl acetate, ethyl acetate, amyl acetate, propyl acetate, butyl acetate, acetone, tetrahydrofuran, 1,3-dioxolan, 1,4-dioxane, cyclohexanone, ethyl formate, nitroethane, methyl ethyl ketone (MEK), methyl isobutyl ketone (MIBK), methyl amyl ketone (MAK), methyl isoamyl ketone (MIAK), toluene, methanol, ethanol, propanol, isopropanol, butanol, t-butanol, sec-butanol, acetic acid, propionic acid, butyric acid and mixtures thereof.

12. A liquid crystal display comprising at least one film of claim 1.

13. A polarizer plate for a liquid crystal display comprising at least one film of claim 1.

14. A wave plate for a liquid crystal display comprising at least one film of claim 1.

15. A single layer compensation sheet comprising the film of claim 1.

16. A multi-layer compensation sheet comprising at least one film of claim 1.

17. The film of claim 1 wherein the film functions as both a substrate for LCD components and as a compensation sheet in liquid crystal displays.

18. The film of claim 1 comprising at least one layer of a multifunctional film wherein the film functions as a substrate or protective layer for liquid crystal display components and provides compensation.

19. The film of claim 1 wherein the film thickness ranges from about 3 microns to about 1000 microns.

20. The film of claim 1 comprising 0-30 weight percent of additives selected from the group comprising matting agents, UV absorbers, antioxidants, and dyes.

21. The film of claim 20 wherein the additives are birefringence enhancing substances selected from the group consisting of liquid crystal compounds, discotic compounds, and/or rod-like compounds.

22. A polarizer for a liquid crystal display comprising the film of claim 1 and another substrate layer, where the second substrate comprises, TAC film, a CAP film with DS_{OH} between 0 and 0.399, a CAB film with DS_{OH} between 0 and 0.399, or cyclic olefin polymer (COP) film.

23. A liquid crystal display comprising the film of claim 1 and a polymer layer, wherein the film is laminated onto the polymer layer.

24. A liquid crystal display comprising the film of claim 1 and a second layer wherein the film is solvent cast onto the second layer.

25. A polarizer for a liquid crystal display comprising a first and a second cellulose acetate film of claim 1 and a polyvinyl alcohol film having a first and second surface, wherein the first and second cellulose acetate films contact the first and second surfaces of the polyvinyl alcohol film and wherein the first and second cellulose acetate films of claim 1 are not saponified.

26. A polarizer for a liquid crystal display comprising a first and a second cellulose acetate film of claim 1 and a polyvinyl alcohol film having a first and second surface, wherein the first and second cellulose acetate films contact the first and second surfaces of the polyvinyl alcohol film and wherein the first and second cellulose acetate films of claim 1 are saponified.

27. The film of claim 2 wherein the film thickness ranges from about 3 microns to about 1000 microns.

28. The film of claim 2 comprising 0-30 weight percent of additives selected from the group consisting of matting agents, UV absorbers, antioxidants, and dyes.

29. The film of claim 28 wherein the additives are birefringence enhancing substances selected from the group consisting of liquid crystal compounds, discotic liquid crystal compounds, and rod-like liquid crystal compounds.

30. A film comprising
70 to 100 weight percent of a cellulose acetate propionate with a degree of substitution of hydroxyl groups from 0.50 to 2.00, a degree of substitution of acetyl groups of 0.01 to 2.59, and a degree of substitution of propionyl groups of 0.01 to 2.59, wherein the sum of the degrees of substitution of acetyl, propionyl, and hydroxyl groups equals 3.0;
0 to 30 weight percent of a plasticizer; and
0 to 30 weight percent of an organic solvent,
wherein the weight percent is based on the total of the cellulose acetate propionate, the plasticizer and the organic solvent.

31. A film comprising:
70 to 100 weight percent of a cellulose acetate propionate with a degree of substitution of hydroxyl groups from 0.65 to 2.00, a degree of substitution of acetyl groups of 0.01 to 2.34, and a degree of substitution of propionyl groups of 0.01 to 2.34, wherein the sum of the degrees of substitution of acetyl, propionyl, and hydroxyl groups equals 3.0;
0 to 30 weight percent of a plasticizer; and
0 to 30 weight percent of an organic solvent,
wherein the weight percent is based on the total of the cellulose acetate propionate, the plasticizer and the organic solvent.

32. A film comprising:
70 to 100 weight percent of a cellulose acetate propionate with a degree of substitution of hydroxyl groups from 0.95 to 2.00, a degree of substitution of acetyl groups of 0.01 to 2.04, and a degree of substitution of propionyl groups of 0.01 to 2.04, wherein the sum of the degrees of substitution of acetyl, propionyl, and hydroxyl groups equals 3.0;
0 to 30 weight percent of a plasticizer; and
0 to 30 weight percent of an organic solvent,
wherein the weight percent is based on the total of the cellulose acetate propionate, the plasticizer and the organic solvent.

33. A film comprising:
70 to 100 weight percent of a cellulose acetate propionate with a degree of substitution of hydroxyl groups from 1.01 to 2.00, a degree of substitution of acetyl groups of 0.01 to 1.99, and a degree of substitution of propionyl groups of 0.01 to 1.99, wherein the sum of the degrees of substitution of acetyl, propionyl, and hydroxyl groups equals 3.0;
0 to 30 weight percent of a plasticizer or a combination of plasticizers; and 0 to 30 weight percent of an organic solvent or blend of organic solvents,
wherein the weight percent is based on the total of the cellulose acetate propionate, the plasticizer and the organic solvent.

34. A film comprising:
70 to 100 weight percent of a cellulose acetate butyrate with a degree of substitution of hydroxyl groups from 0.40 to 2.00, a degree of substitution of acetyl groups of 0.01 to 2.59, and a degree of substitution of butyryl groups of 0.01 to 2.59, wherein the sum of the degrees of substitution of acetyl, butyryl, and hydroxyl groups equals 3.0;
0 to 30 weight percent of a plasticizer; and
0 to 30 weight percent of an organic solvent,
wherein the weight percent is based on the total of the cellulose acetate butyrate, the plasticizer and the organic solvent.

35. A film comprising:
70 to 100 weight percent of a cellulose acetate butyrate with a degree of substitution of hydroxyl groups from 0.65 to 2.00, a degree of substitution of acetyl groups of 0.01 to 2.34, and a degree of substitution of butyryl groups of 0.01 to 2.34, wherein the sum of the degrees of substitution of acetyl, butyryl, and hydroxyl groups equals 3.0;
0 to 30 weight percent of a plasticizer; and
0 to 30 weight percent of an organic solvent,
wherein the weight percent is based on the total of the cellulose acetate butyrate, the plasticizer and the organic solvent.

36. A film comprising:
70 to 100 weight percent of a cellulose acetate butyrate with a degree of substitution of hydroxyl groups from 0.95 to 2.00, a degree of substitution of acetyl groups of 0.01 to 2.04, and a degree of substitution of butyryl groups of 0.01 to 2.04, wherein the sum of the degrees of substitution of acetyl, butyryl, and hydroxyl groups equals 3.0;
0 to 30 weight percent of a plasticizer; and
0 to 30 weight percent of an organic solvent,
wherein the weight percent is based on the total of the cellulose acetate butyrate, the plasticizer and the organic solvent.

37. A film comprising:
70 to 100 weight percent of a cellulose acetate butyrate with a degree of substitution of hydroxyl groups from 1.01 to 2.00, a degree of substitution of acetyl groups of 0.01 to 0.98, and a degree of substitution of butyryl groups of 0.01 to 0.98, wherein the sum of the degrees of substitution of acetyl, butyryl, and hydroxyl groups equals 3.0;
0 to 30 weight percent of a plasticizer; and
0 to 30 weight percent of an organic solvent,
wherein the weight percent is based on the total of the cellulose acetate butyrate, the plasticizer and the organic solvent.

38. The film of claim 1 where the number average molecular weight (Mₙ) of the cellulose acetate, as determined by gel permeation chromatography (GPC), ranges from 1,500 to 200,000.

39. The film of claim 1 where the inherent viscosity (IV) of the cellulose acetate ranges from 0.050 to 3.0 deciliters/gram.

40. A process of forming a high DS_{OH} film, the process comprising
hydrolyzing a cellulose ester having a degree of substitution of acyl groups ranging from 2.6 to 3.0 by contacting the cellulose ester with an acidic or basic saponification agent to produce a hydrolyzed cellulose ester, and
forming a film from the hydrolyzed cellulose ester,
wherein the film has a negative birefringence at 633 nm, Δn⁶³³, compared to a film made from the unhydrolyzed cellulose ester.

41. The process of claim 40 wherein the cellulose ester is dissolved in an organic solvent, heated to a temperature ranging from about 0° C. to about 100° C. in the presence of water and a saponification catalyst.

42. The process of claim 40 further comprising neutralizing the saponification agent.

43. The process of claim 41 wherein the organic solvent comprises an organic carboxylic acid.

44. The process of claim 43 wherein the organic solvent comprises acetic acid, propionic acid, butyric acid or mixtures thereof.

45. The process of claim 40 where the saponification agent comprises a mineral acid.

46. The process of claim 45 where the saponification agent comprises sulfuric acid.

47. The process of claim 45 where the saponification agent comprises hydrochloric acid.

48. The process of claim 40 where the saponification agent comprises a base.

49. The process of claim 40 where the saponification agent is a solid.

50. A film comprising:
70 to 100 weight percent of a cellulose acetate with a degree of substitution of hydroxyl groups from greater than 1.23 to 2.00;
0 to 30 weight percent of a plasticizer; and
0 to 30 weight percent of an organic solvent,
wherein the weight percent is based on the total weight of the cellulose acetate, the plasticizer and the organic solvent and
wherein the film is stretched.

51. The film of claim 50 where the film is biaxially stretched.

52. The film of claim 50 where the film is uniaxially stretched.

53. The film of claim 50 where the film is planar stretched.

54. The film of claim 50 where the film is stretched at a temperature greater than the Tg of the film.

55. The film of claim 50 with an Rₜₕ between −240 and −300 and being 60 micron thick after stretching.

56. The film of claim 50 with an Rₜₕ greater than (i.e. more negative than) −300 and being 60 micron thick after stretching.

57. A film comprising:
70 to 100 weight percent of a cellulose acetate with a degree of substitution of hydroxyl groups from greater than 1.01 to 2.00;
0 to 30 weight percent of a plasticizer; and
0 to 30 weight percent of an organic solvent,
wherein the weight percent is based on the total weight of the cellulose acetate, the plasticizer and the organic solvent and
wherein the film is stretched.

58. The film of claim 57 wherein the film is biaxially stretched.

59. The film of claim 57 wherein the film is uniaxially stretched.

60. The film of claim 57 wherein the film is planar stretched.

61. The film of claim 57 wherein the film is stretched at a temperature greater than the Tg of the film.

62. The film of claim 57 having a 60 micron thickness and an Rₜₕ between −240 and −300.

63. The film of claim 57 having a 60 micron thickness and an Rₜₕ greater than (i.e. more negative than) −300.
